(19) United States
(12) Patent Application Publication
(10) Pub. No.: US 2026/0229786 A1
(43) Pub. Date: Aug. 6, 2026

(54) ANTENNA DEVICE

(71) Applicant: Panasonic Intellectual Property Management Co., Ltd., Osaka (JP)

(72) Inventors: Toshiki MORI, Ishikawa (JP); Ken TAKAHASHI, Ishikawa (JP); Koji TAKINAMI, Kanagawa (JP); Kosei NAKANO, Kyoto (JP)

(73) Assignee: Panasonic Intellectual Property Management Co., Ltd., Osaka (JP)

(21) Appl. No.: 19/150,357

(22) PCT Filed: Dec. 19, 2023
(86) PCT No.: PCT/JP2023/045438

§ 371 Date: Jul. 23, 2025

(30) Foreign Application Priority Data
Feb. 9, 2023 (JP) 2023-018334

(51) Int. Cl. H01Q 15/00; H01Q 1/22; H01Q 1/38

(52) U.S. Cl. CPC H01Q 15/0086; H01Q 1/2225; H01Q 1/38

(57) ABSTRACT

This antenna device comprises: a substrate; an antenna element formed on the surface of the substrate; a line which is formed on the surface of the substrate and connects the antenna element and a control circuit for controlling the impedance characteristics of the antenna element; and a circuit that is formed on the surface of the substrate and suppresses a high-frequency signal superposed on the line. A first electrical length in the thickness direction of the substrate in a section where the antenna element is formed and a second electrical length in the thickness direction of the substrate in a section where the circuit is formed are different.

### TECHNICAL FIELD

The present disclosure relates to an antenna apparatus.

### BACKGROUND ART

In recent years, mobile communication using a high-frequency band such as a millimeter wave band or a terahertz wave band has been studied. In the above-described high-frequency band, the straightness of electromagnetic waves is higher than that in a microwave band, and there is a concern that a blind area of electromagnetic waves may occur in an obstructed field. Accordingly, the introduction of a Reconfigurable Intelligent Surface (hereinafter, referred to as an RIS) that electronically controls a reflection direction of electromagnetic waves has been studied.

The RIS is composed of a plurality of antenna elements, and changes the impedance characteristics of each antenna element by electronically controlling a switching device mounted in the plurality of antenna elements. The RIS reflects electromagnetic waves toward a particular direction by changing the impedance characteristics of a particular antenna element among the plurality of antenna elements.

The RIS includes, for example: a switching device that changes the impedance characteristics of each antenna element; a control circuit that controls the switching device; and a bias line that connects the switching device and the control circuit. The RIS performs high-frequency isolation between the antenna element and the bias line such that electromagnetic waves (high-frequency signal) reflected by the antenna element do not enter the control circuit.

In an antenna apparatus of Patent Literature (hereinafter referred to as “PTL”) 1, a bias line is formed in a layer different from that for an antenna element, and a choke circuit that reduces high-frequency signals of the bias line is formed by a via and an inner layer's circular pattern. In the antenna apparatus of PTL 1, this choke circuit performs high-frequency isolation between the antenna element and the bias line.

In an antenna apparatus of Non-Patent Literature (hereinafter referred to as “NPL”) 1, a choke circuit is formed on a front surface of a board of a dielectric by using the board, a ground on a board back surface, and a fan-shaped stub connected to a bias line. In the antenna apparatus of NPL 2, the choke circuit is formed in the identical layer (board front surface) as that for an antenna element, and thus, no via is required in contrast to the antenna apparatus of PTL 1 in which the choke circuit and the antenna element are formed in different layers.

### CITATION LIST

### Patent Literature

PTL 1
Japanese Patent Application Laid-Open No. 2010-200263

### Non-Patent Literature

NPL 1
“Design_and_Evaluation_of_Reconfigurable_Intelligent_Surfaces_in_Real-World Environment”, IEEE Open Journal of the Communications Society (Volume: 3), pp. 462 to 474, Mar. 10, 2022, GEORGIOS C. TRICHOPOULOS

### SUMMARY OF INVENTION

When the effective interlayer distance between the antenna element formed on the board front surface and the ground formed on the board back surface is increased, the radiation performance of the antenna element improves.

When the effective interlayer distance between the choke circuit formed on the board front surface and the ground on the board back surface is decreased, the high-frequency isolation performance of the choke circuit improves, and spurious radiation from the choke circuit and the bias line is suppressed.

For this reason, when the board is thickened in order to improve the radiation performance of the antenna element, the high-frequency isolation performance of the choke circuit decreases, and spurious radiation from the choke circuit and the bias line increases.

When the board is thinned in order to improve the high-frequency isolation performance of the choke circuit and suppress spurious radiation from the choke circuit and the bias line, the radiation performance of the antenna element decreases.

As described above, since the radiation performance of the antenna apparatus, and the high-frequency isolation performance and spurious radiation performance are contrary to the thickness of the board, the configuration of NPL 2 in which the antenna element and the choke circuit are formed on the board front surface and the ground is formed on the board back surface may have difficulty in satisfying a desired radiation performance of the antenna apparatus and desired high-frequency isolation performance and spurious radiation performance.

One non-limiting and exemplary embodiment of the present disclosure facilitates providing an antenna apparatus capable of satisfying a desired radiation performance, and desired high-frequency isolation performance and spurious radiation performance.

An antenna apparatus according to an exemplary embodiment of the present disclosure includes: a board; an antenna element that is formed on a front surface of the board; a line that is formed on the front surface of the board and connects the antenna element and a control circuit which controls an impedance characteristic of the antenna element; and a circuit that is formed on the front surface of the board and suppresses a high-frequency signal superposed on the line. A first electrical length, which is an electrical length in a thickness direction of the board in a portion where the antenna element is formed, and a second electrical length, which is an electrical length in the thickness direction of the board in a portion where the circuit is formed, are different from each other.

It should be noted that general or specific embodiments may be implemented as a system, an apparatus, a method, an integrated circuit, a computer program, a storage medium, or any selective combination thereof.

According to an exemplary embodiment of the present disclosure, an antenna apparatus is capable of satisfying a desired radiation performance, and desired high-frequency isolation performance and spurious radiation performance.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a front view of an antenna apparatus according to Embodiment 1;

FIG. 2A is a perspective view of a cell of the antenna apparatus;

FIG. 2B is a cross-sectional view taken along an A-A arrow of the cell of FIG. 2A;

FIG. 2C is a front view of the cell;

FIG. 3A is a perspective view of a cell according to a variation of the present disclosure;
FIG. 3B is a cross-sectional view taken along an A-A arrow of the cell of FIG. 3A;
FIG. 4 is a perspective view of the cell illustrated in FIGS. 3A and 3B, from which bias lines and stubs are omitted;
FIG. 5A is a perspective view of a cell according to an existing technology;
FIG. 5B is a cross-sectional view taken along an A-A arrow of the cell of FIG. 5A;
FIG. 6 is a perspective view of the cell illustrated in FIGS. 5A and 5B, from which bias lines and stubs are omitted;
FIG. 7A is a diagram illustrating reflection characteristics;
FIG. 7B is a diagram illustrating reflection characteristics;
FIG. 8A is a diagram illustrating reflection characteristics;
FIG. 8B is a diagram illustrating reflection characteristics;
FIG. 9A is a perspective view illustrating a part of the cell according to the present disclosure;
FIG. 9B is a cross-sectional view taken along an A-A arrow of the cell of FIG. 9A;
FIG. 10A is a perspective view illustrating a part of the cell according to an existing technology;
FIG. 10B is a cross-sectional view taken along an A-A arrow of the cell of FIG. 10A;
FIG. 11A is a diagram illustrating isolation characteristics;
FIG. 11B is a diagram illustrating radiation power;
FIG. 12A is a diagram illustrating isolation characteristics;
FIG. 12B is a diagram illustrating radiation power;
FIG. 13A is a diagram illustrating a variation of the stubs;
FIG. 13B is a diagram illustrating a variation of the stubs;
FIG. 13C is a diagram illustrating a variation of the stubs;
FIG. 13D is a diagram illustrating a variation of the stubs;
FIG. 14A is a diagram illustrating a variation of an antenna element;
FIG. 14B is a diagram illustrating a variation of the antenna element;
FIG. 14C is a diagram illustrating a variation of the antenna element;
FIG. 15A is a perspective view of a cell of the antenna apparatus according to Embodiment 2;
FIG. 15B is a cross-sectional view taken along an A-A arrow of the cell of FIG. 15A;
FIG. 15C is a front view of the cell of FIG. 15A;
FIG. 16A is a diagram illustrating a variation of a board;
FIG. 16B is a diagram illustrating the variation of the board;
FIG. 17A is a diagram illustrating a variation of the board;
FIG. 17B is a diagram illustrating the variation of the board;
FIG. 18A is a diagram illustrating a variation of an antenna element;
FIG. 18B is a diagram illustrating the variation of the antenna element;
FIG. 19A is a diagram illustrating a variation of stubs;
FIG. 19B is a diagram illustrating a variation of the stubs;
FIG. 19C is a diagram illustrating a variation of the stubs;
FIG. 19D is a diagram illustrating a variation of the stubs;
FIG. 20A is a diagram illustrating a variation of the antenna element;
FIG. 20B is a diagram illustrating a variation of the antenna element;
FIG. 20C is a diagram illustrating a variation of the antenna element;
FIG. 21A is a perspective view of a cell of the antenna apparatus according to Embodiment 3;
FIG. 21B is a cross-sectional view taken along an A-A arrow of the cell of FIG. 21A;
FIG. 21C is a front view of the cell of FIG. 21A;
FIG. 22A is a diagram illustrating a variation of a stub;
FIG. 22B is a diagram illustrating a variation of the stub;
FIG. 22C is a diagram illustrating a variation of the stub;
FIG. 22D is a diagram illustrating a variation of the stub;
FIG. 23A is a diagram illustrating a variation of the antenna element;
FIG. 23B is a diagram illustrating a variation of the antenna element; and
FIG. 23C is a diagram illustrating a variation of the antenna element.

### DESCRIPTION OF EMBODIMENTS

Hereinafter, embodiments of the present disclosure will be described in detail with reference to the accompanying drawings as appropriate. However, a detailed description more than necessary may be omitted, such as a detailed description of an already well-known matter and a duplicated description for a substantially identical configuration, to avoid the following description becoming unnecessarily redundant and to facilitate understanding by those skilled in the art.

Note that, the accompanying drawings and the following description are provided for those skilled in the art to sufficiently understand the present disclosure, and are not intended to limit the subject matter described in the claims.

Hereinafter, the high-frequency isolation performance by a choke circuit and spurious radiation of the choke circuit and a bias line may be collectively referred to as the radiation degree of influence in the choke circuit and the bias line. The lower the radiation degree of influence, the more preferable the radiation degree of influence is. Note that, a low radiation degree of influence means that the high-frequency isolation performance by the choke circuit is high and spurious radiation from the choke circuit and the bias line is small.

### Embodiment 1

In Embodiment 1, a structure in which the effective interlayer distance between an antenna element and a ground and the effective interlayer distance between a bias line and the ground are physically different from each other will be described. Note that, the effective interlayer distance refers to a distance (electrical length) for which a wavelength shortening effect attainable by a dielectric is taken into consideration.

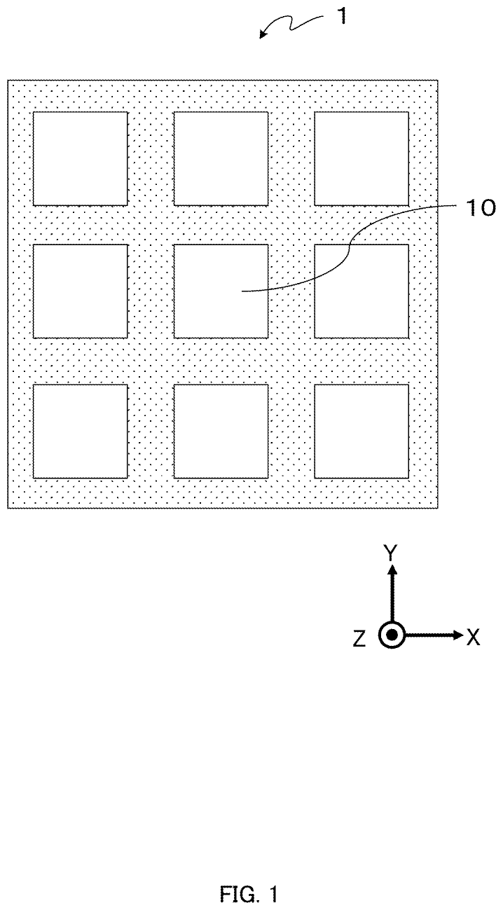

As illustrated in FIG. 1, antenna apparatus 1 is formed of a plurality of cells 10. Cells 10 are arranged in a lattice shape. Antenna apparatus 1 is, for example, an RIS, and reflects electromagnetic waves toward a particular direction by changing the impedance characteristics of an antenna element included in cell 10.

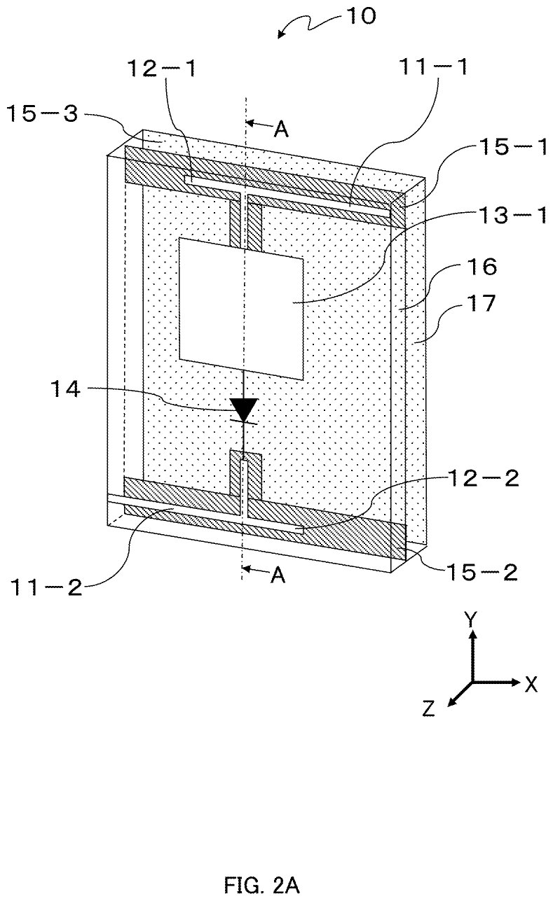

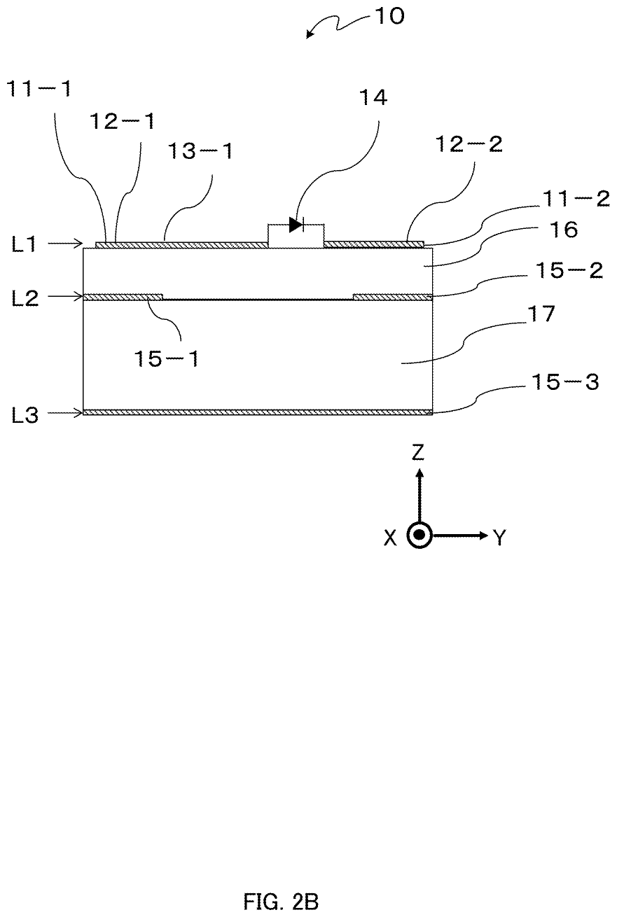

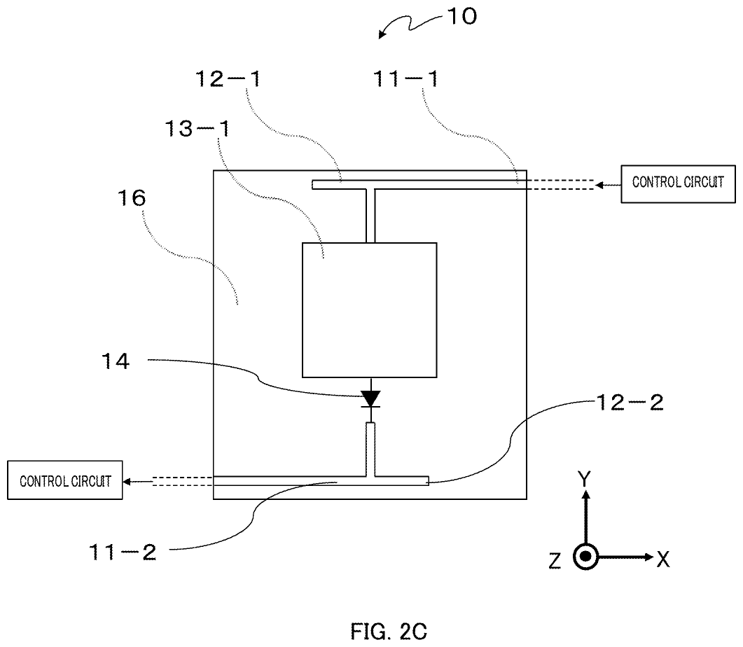

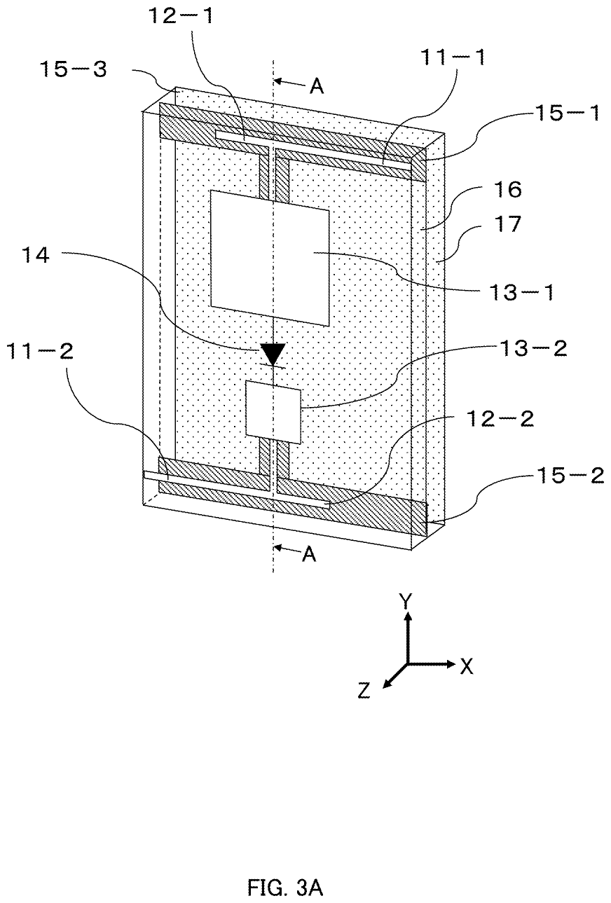

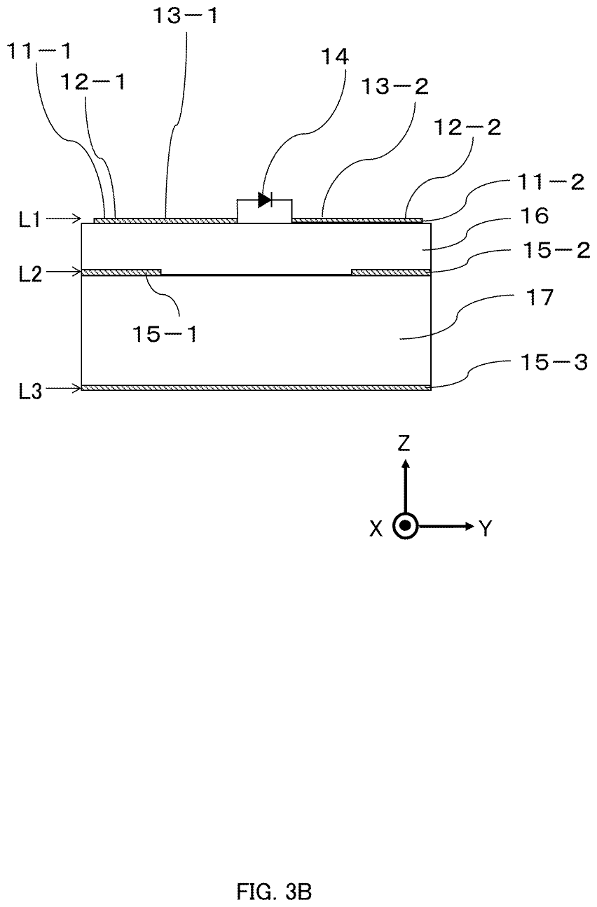

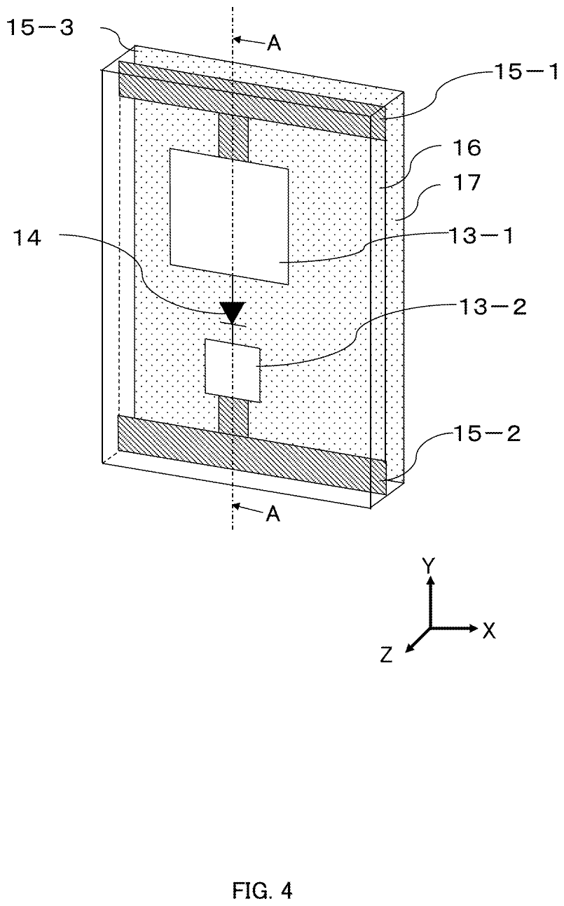

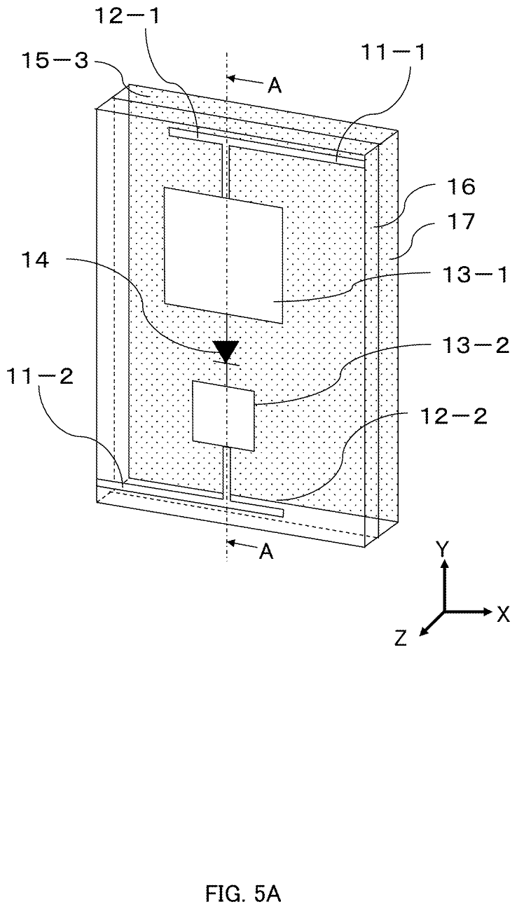

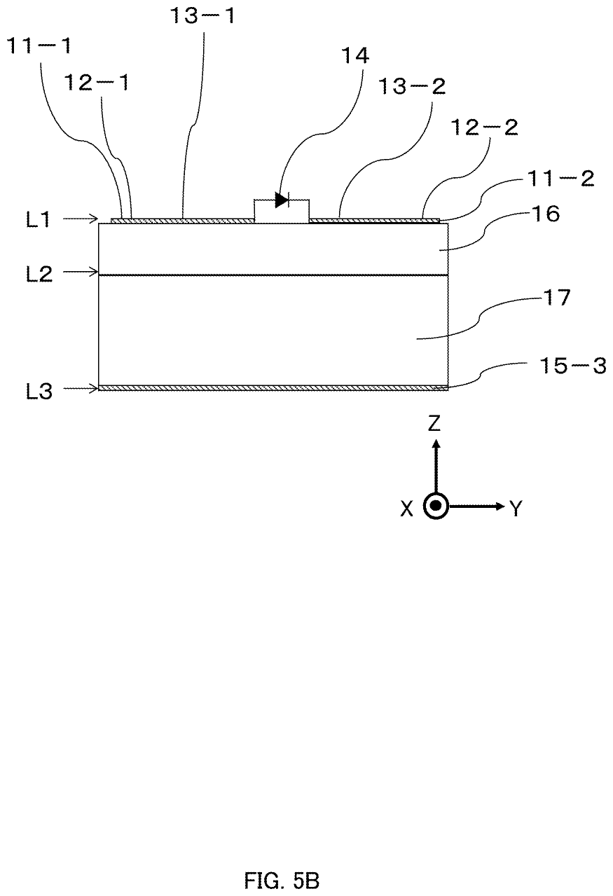

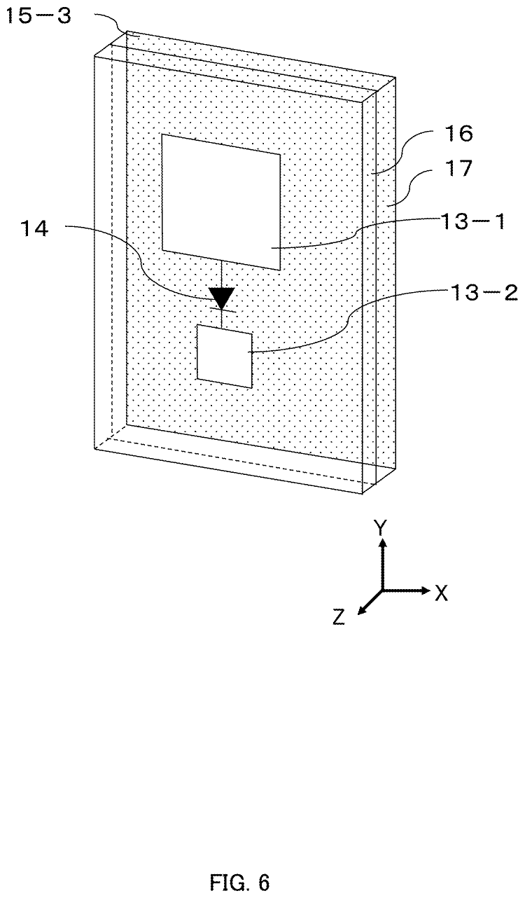

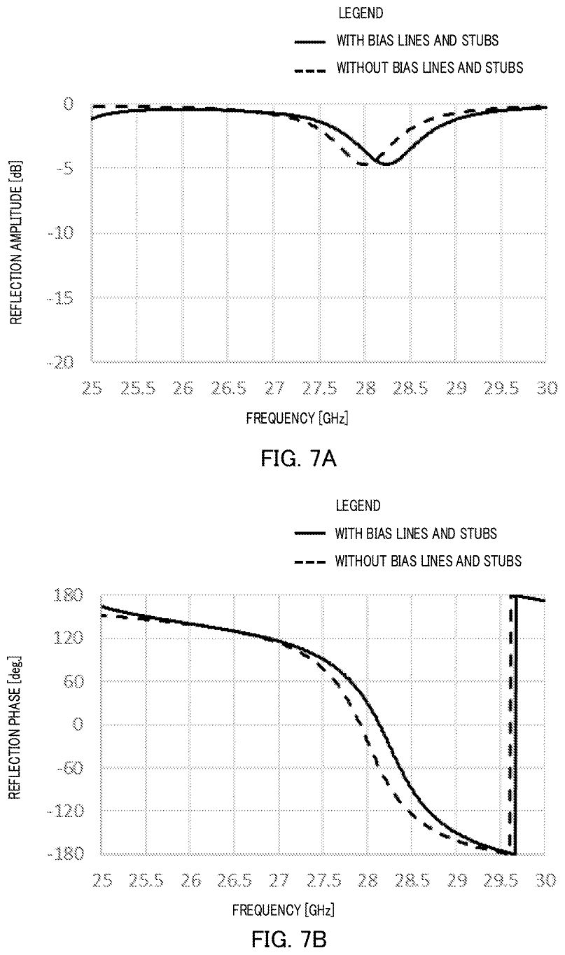

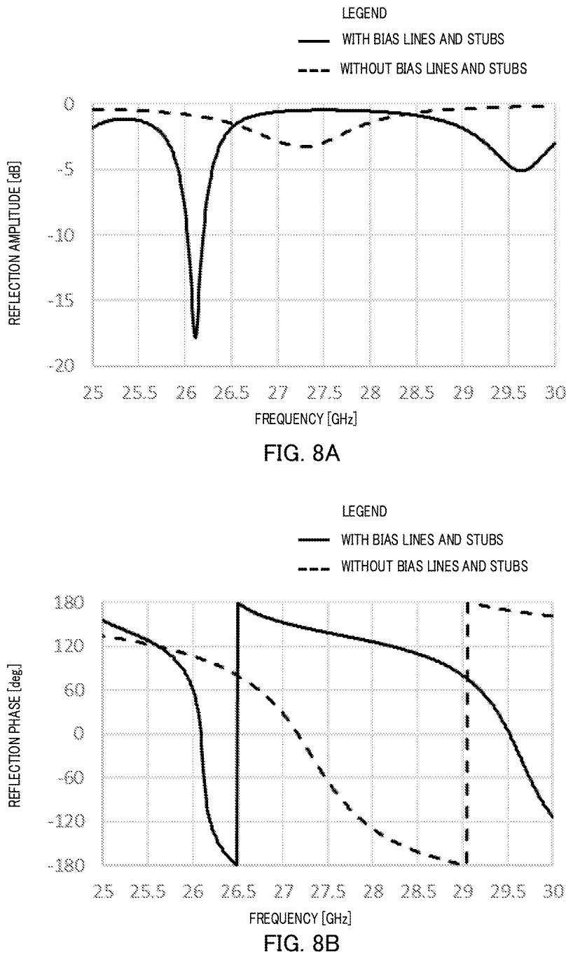

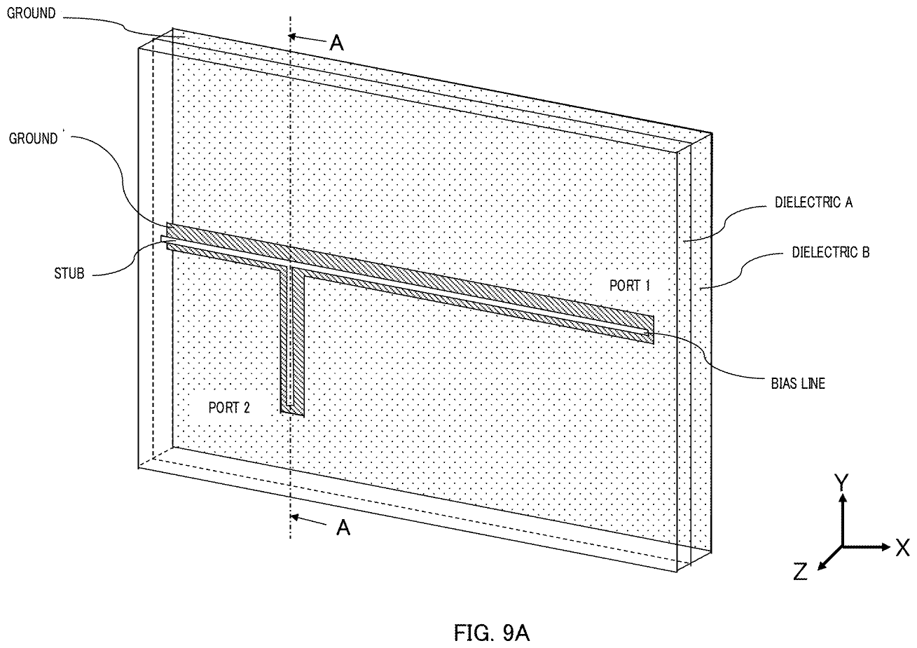

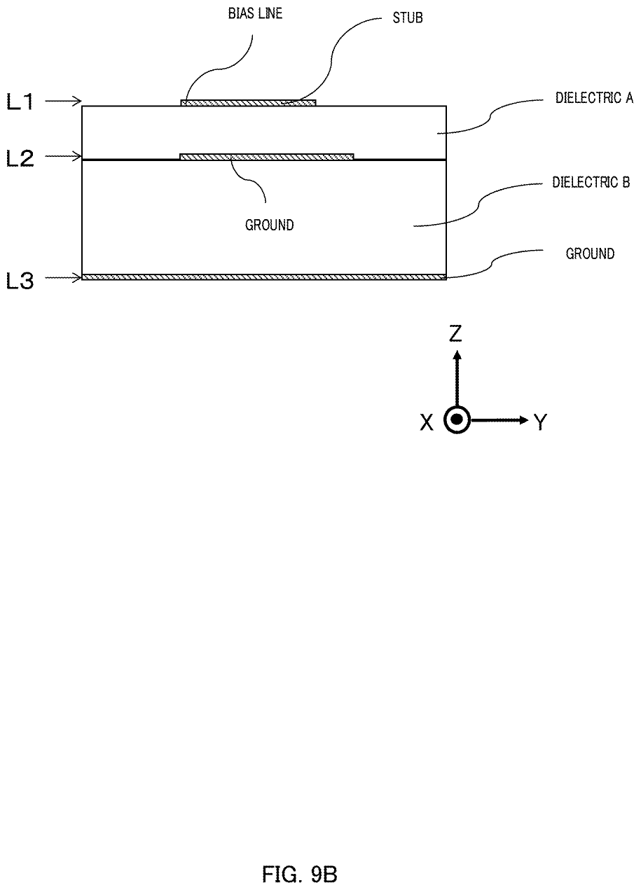

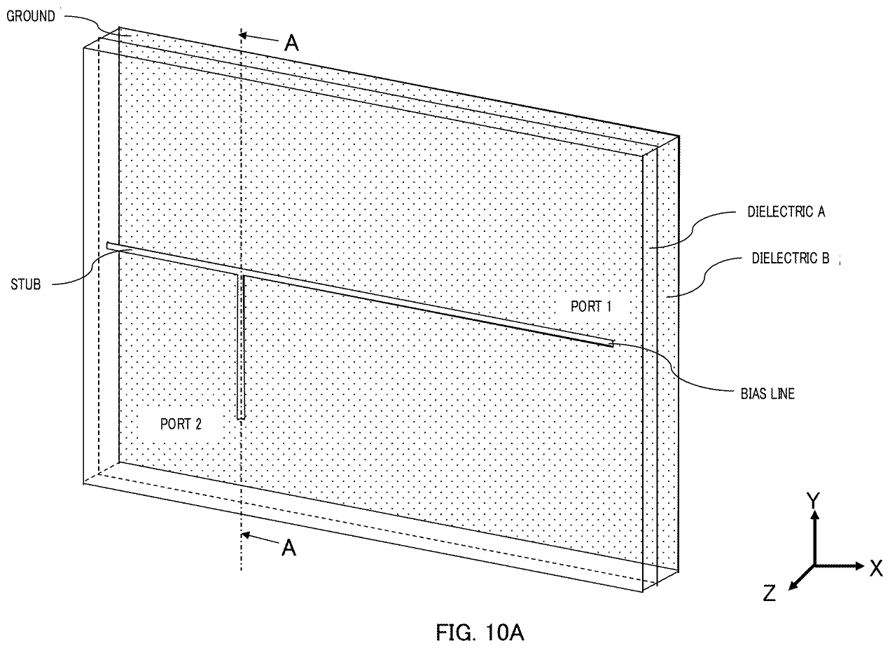

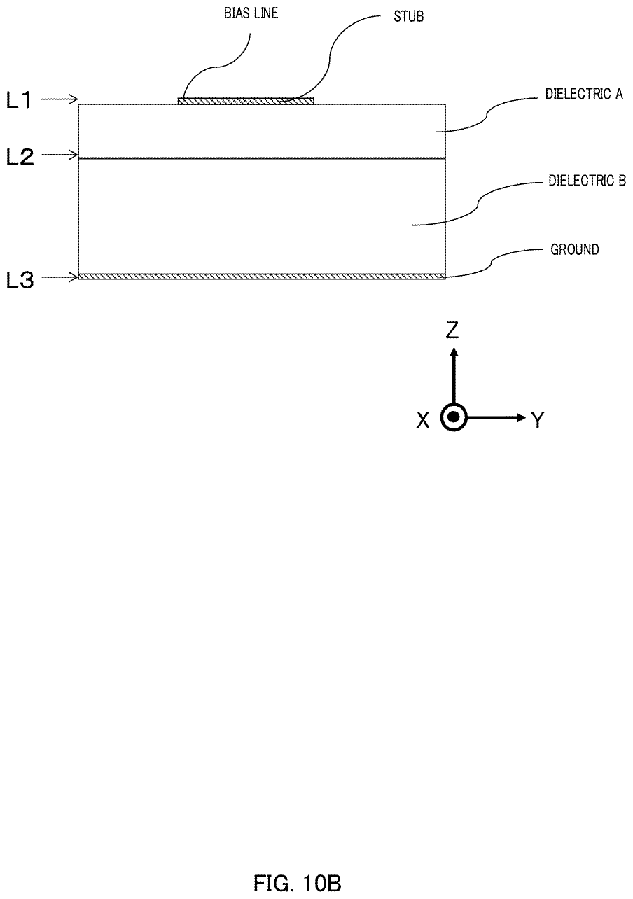

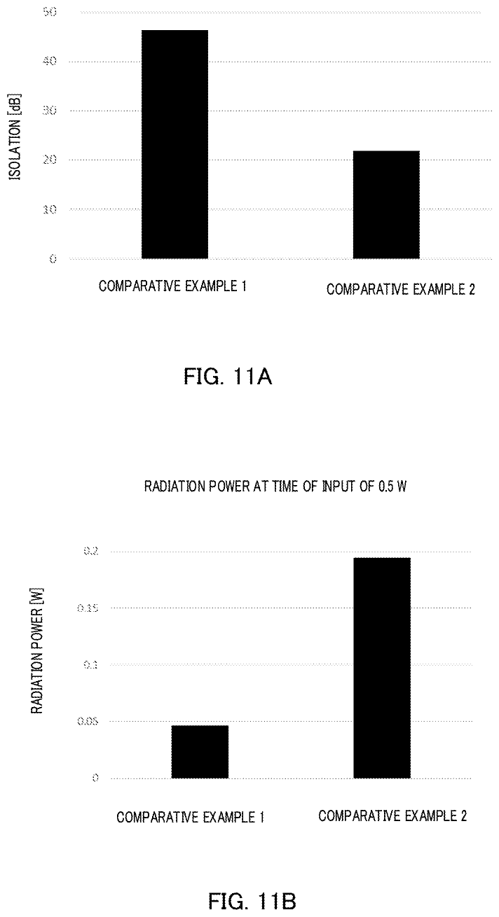

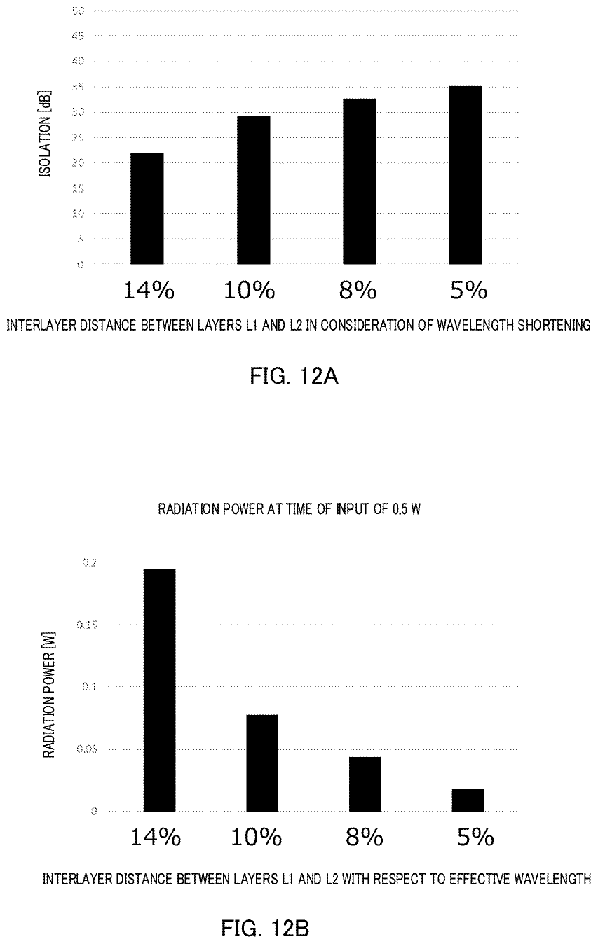

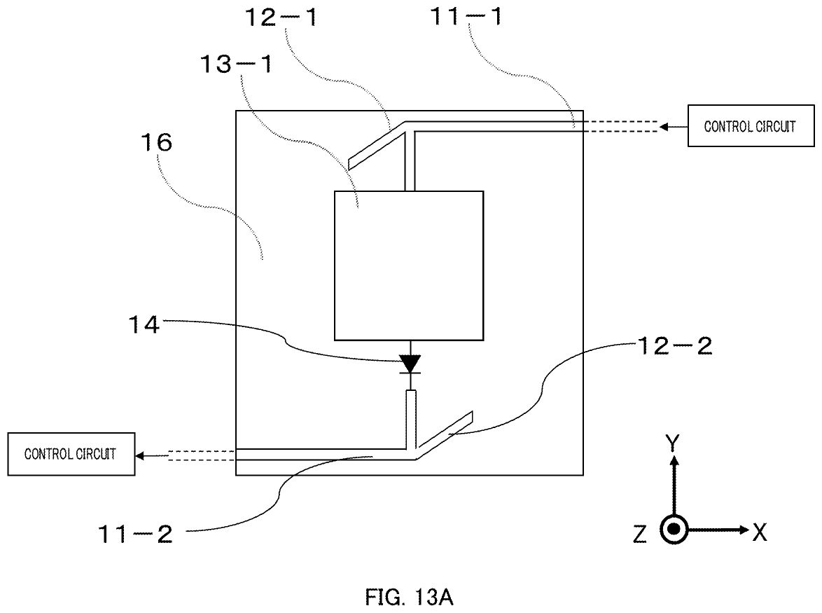

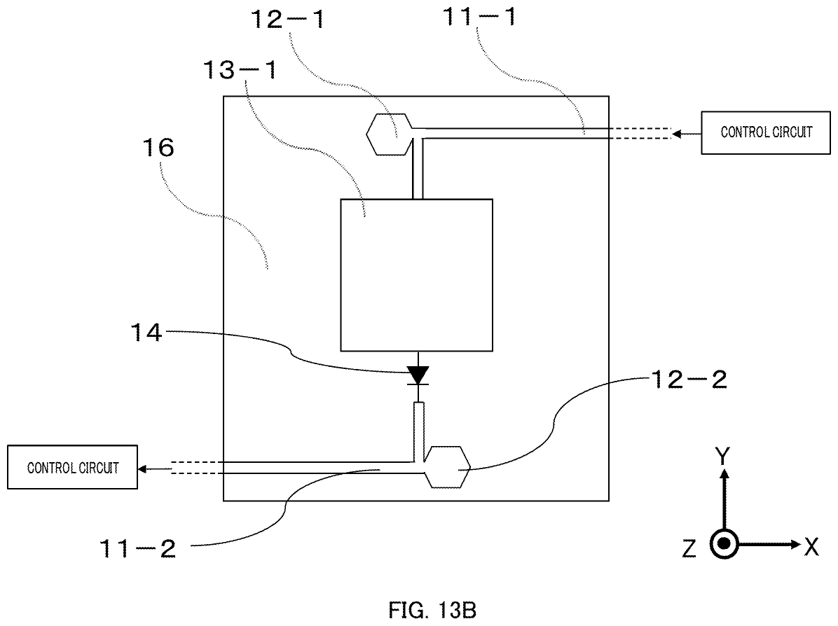

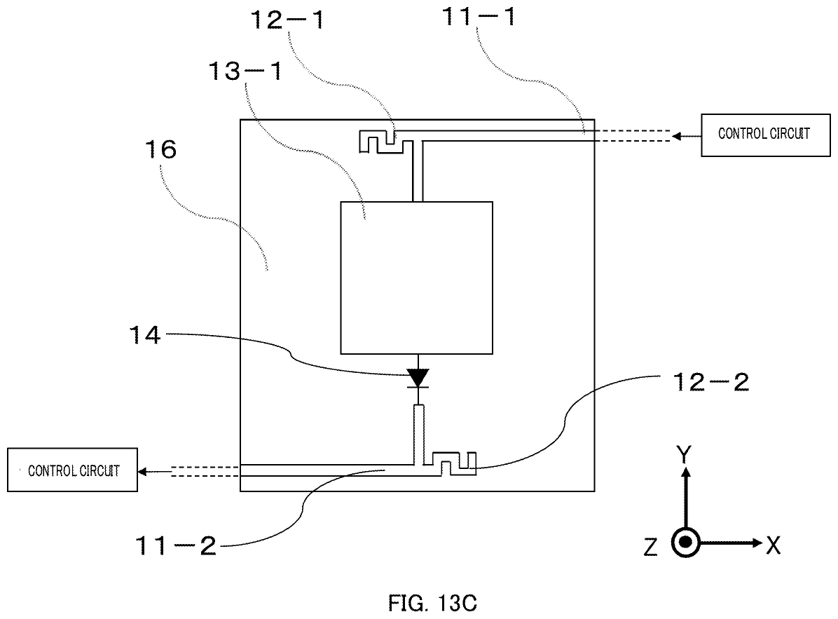

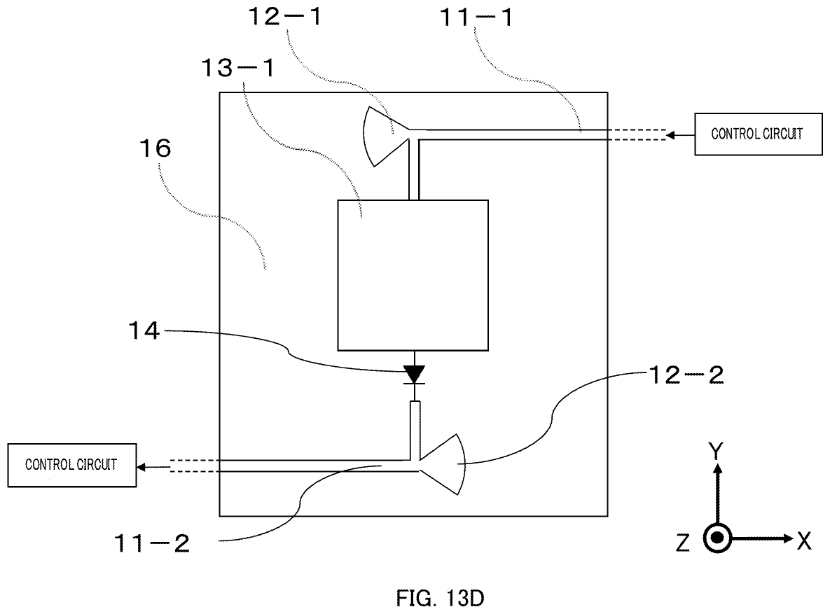

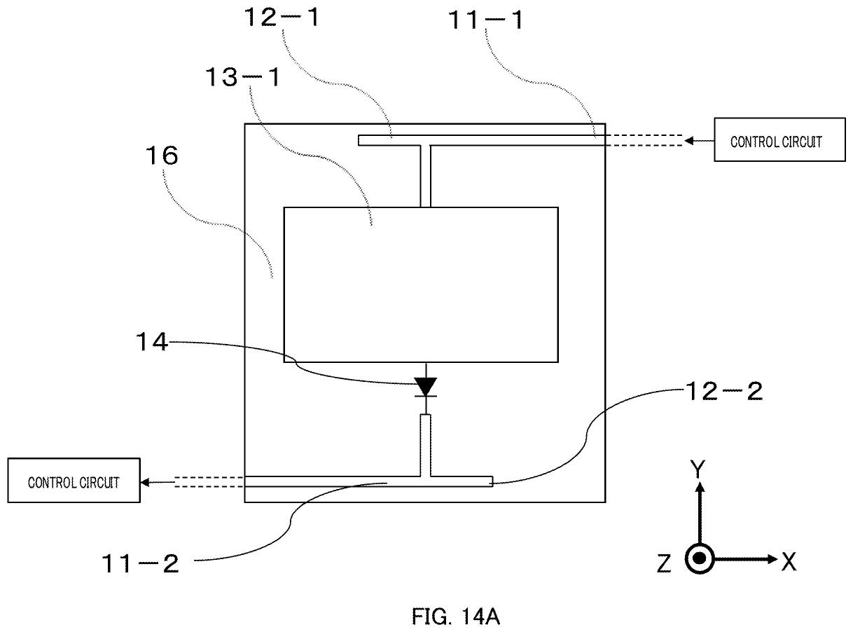

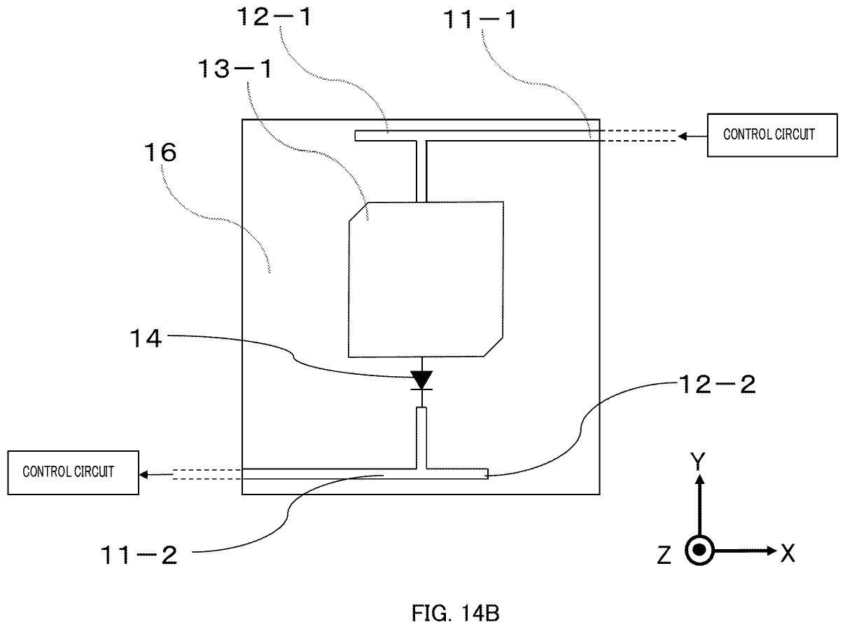

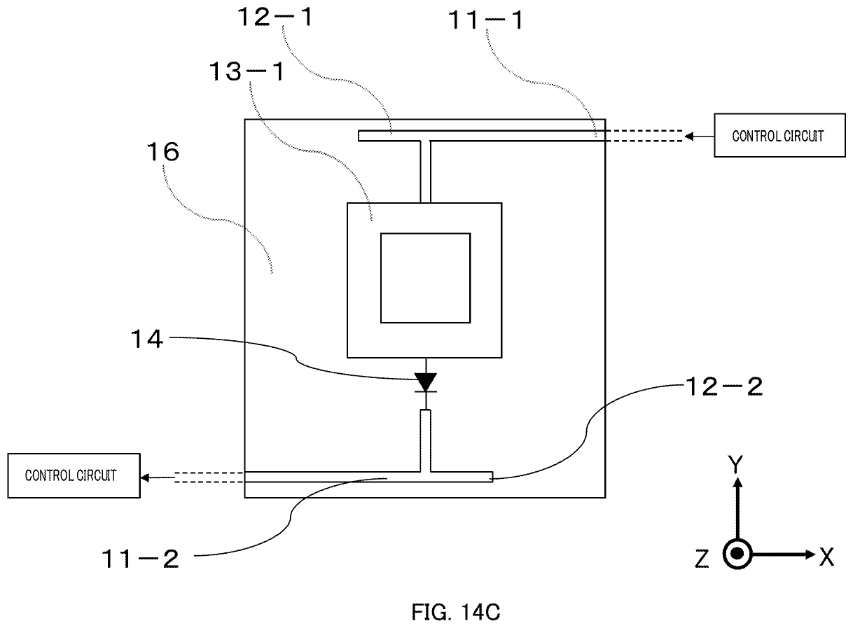

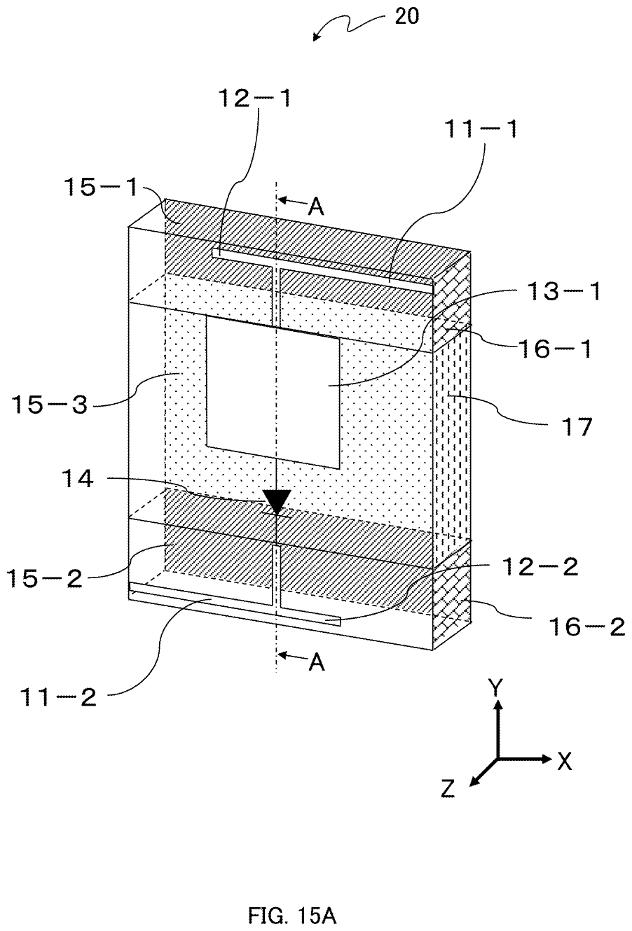

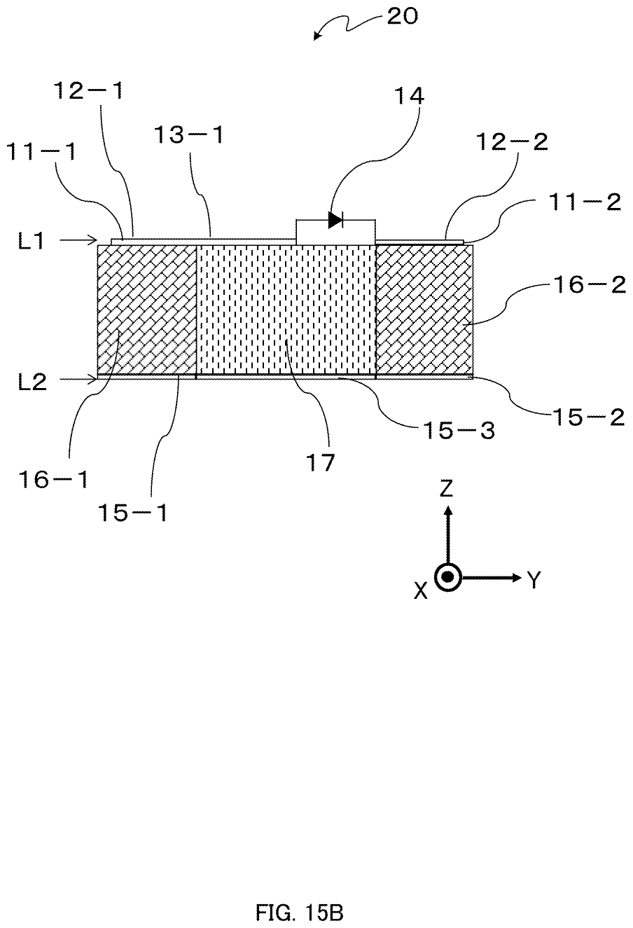

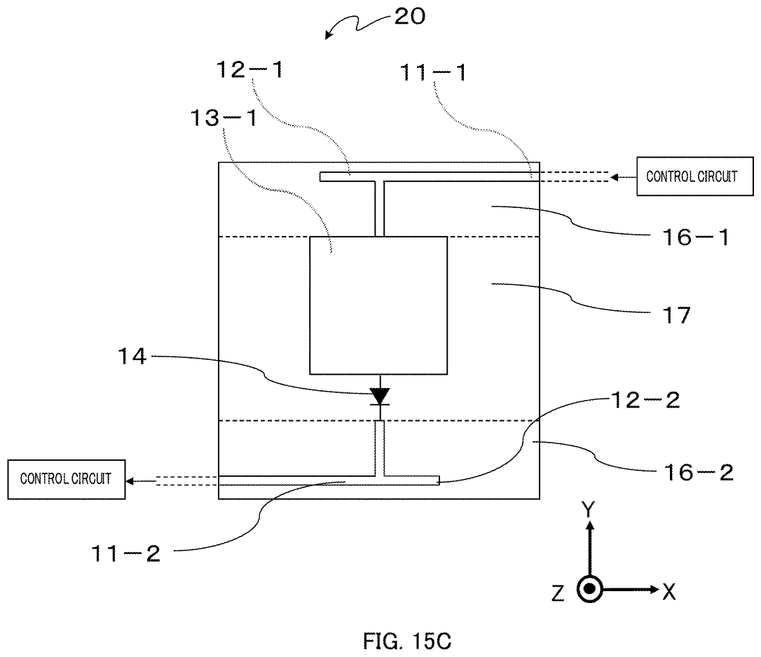

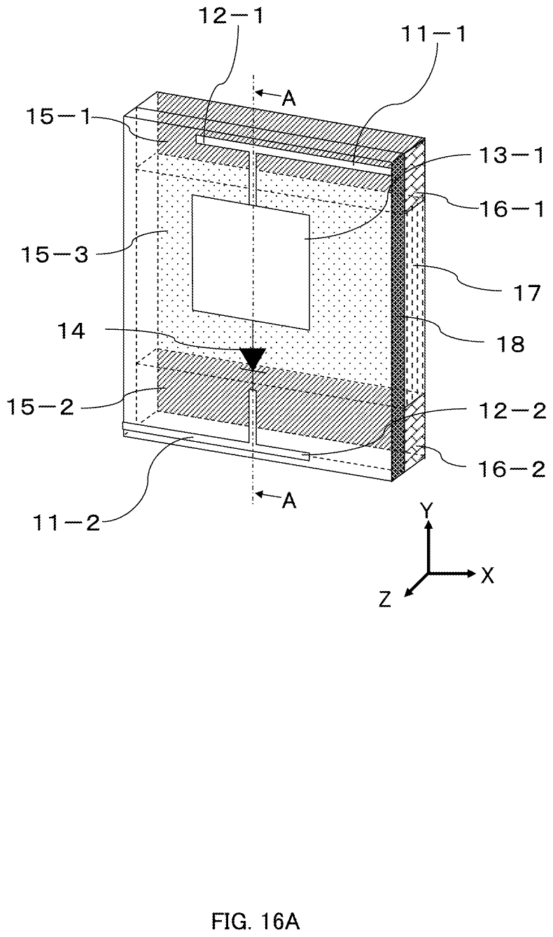

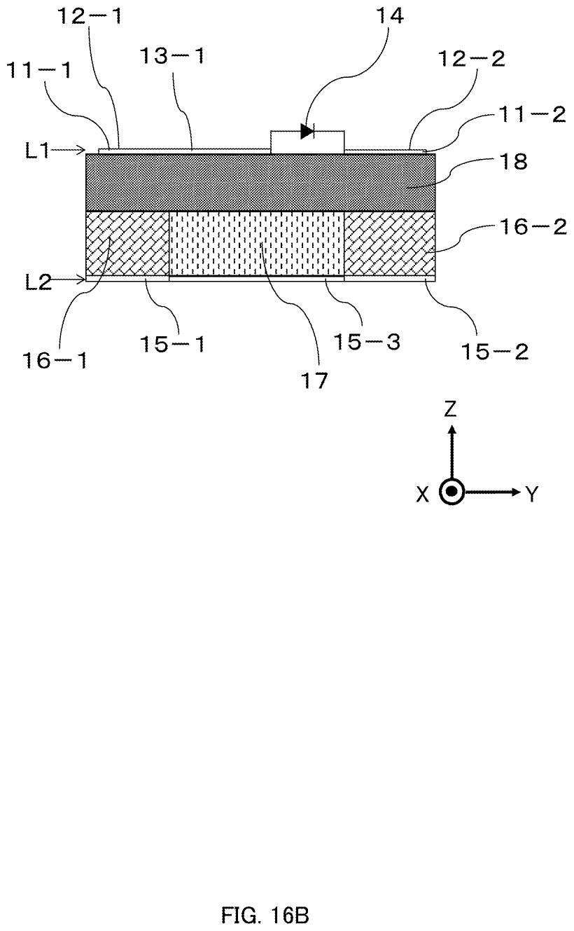

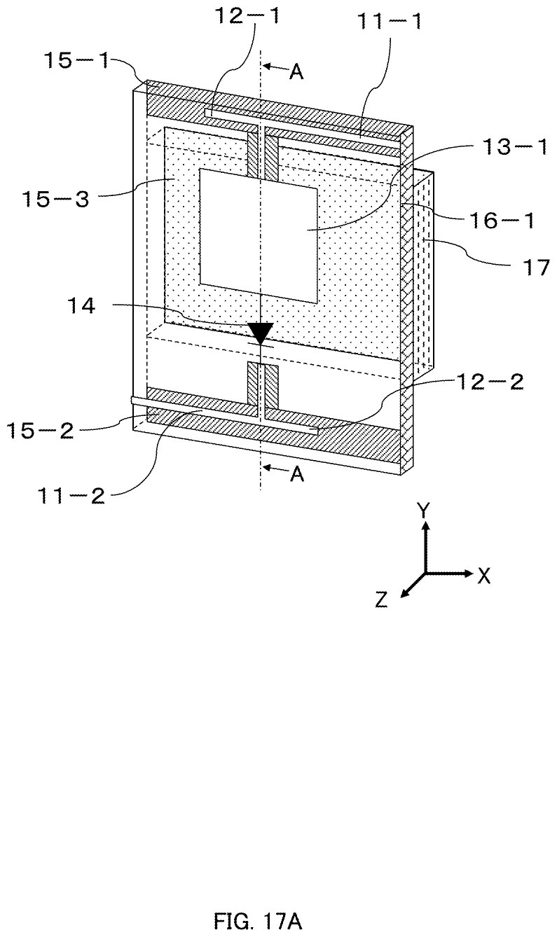

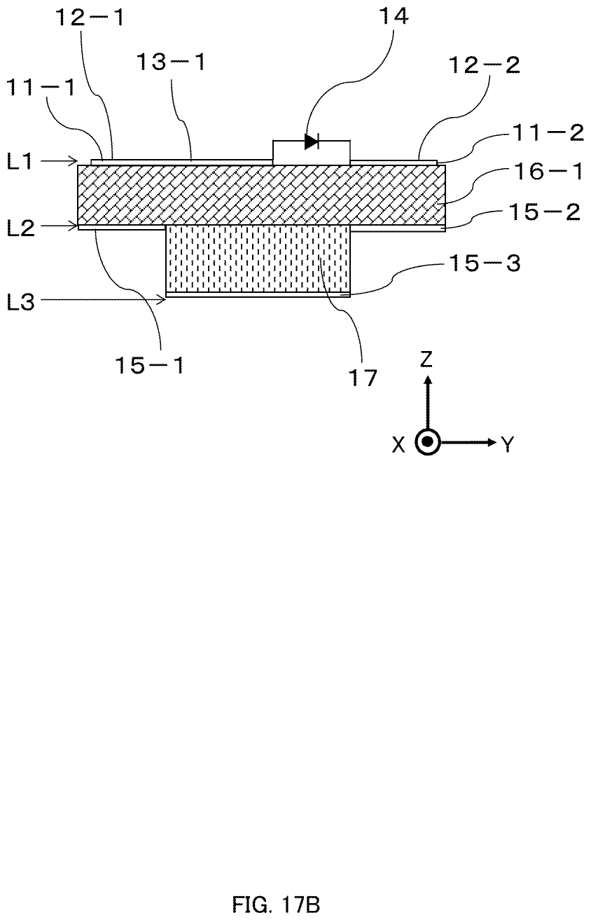

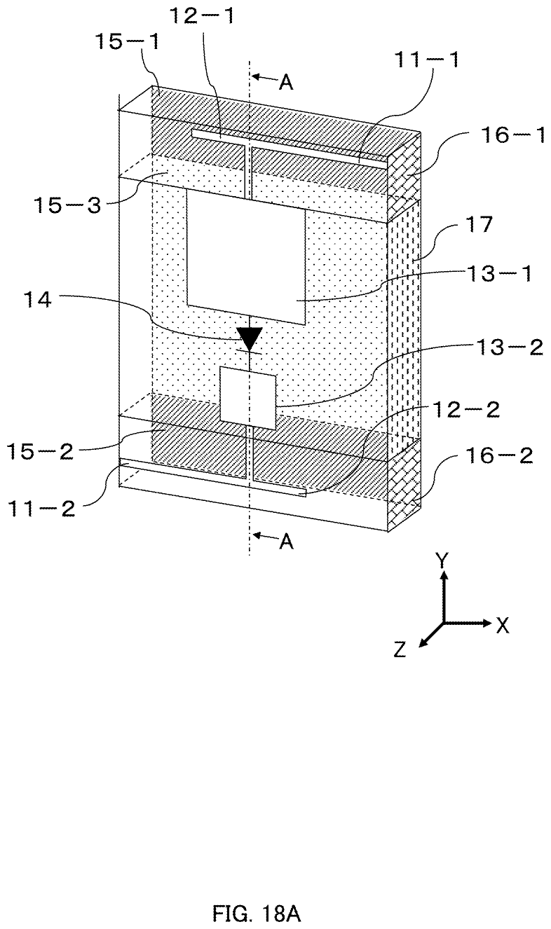

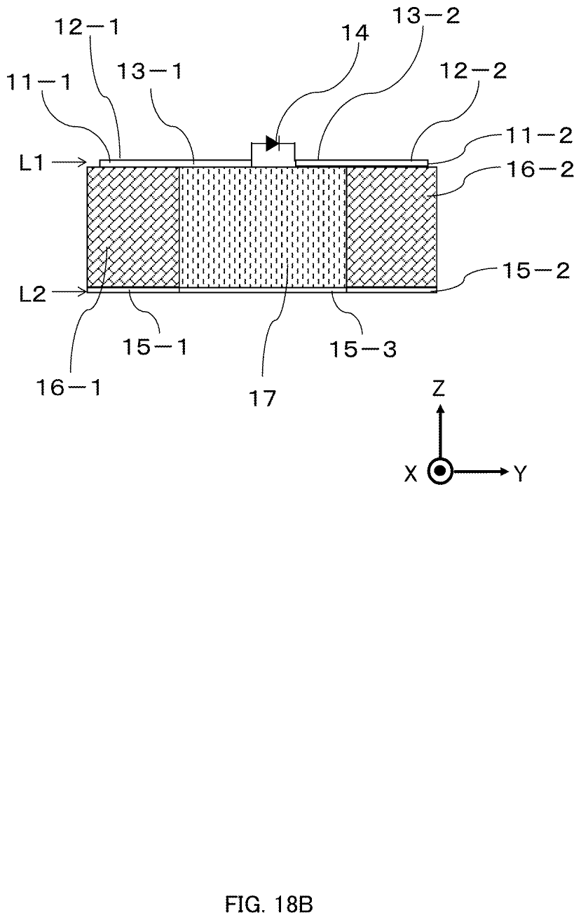

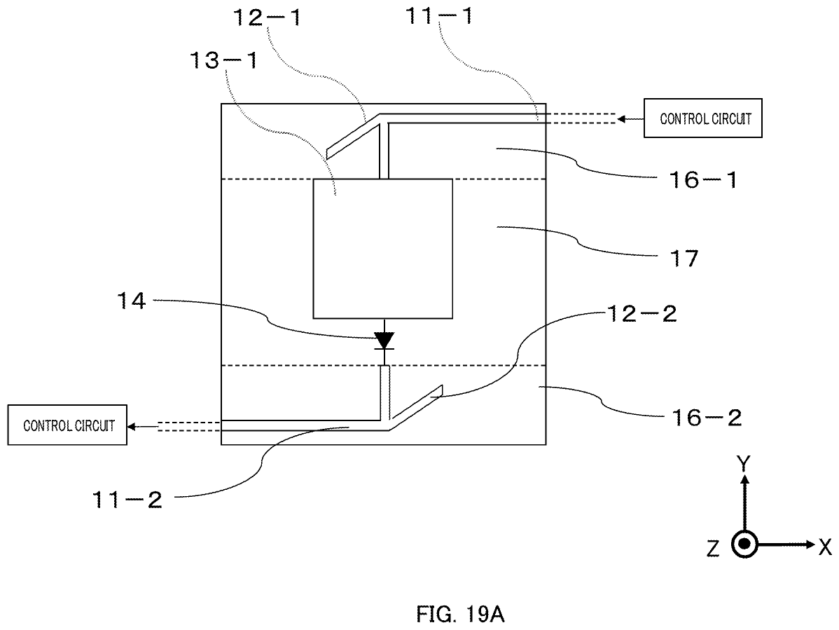

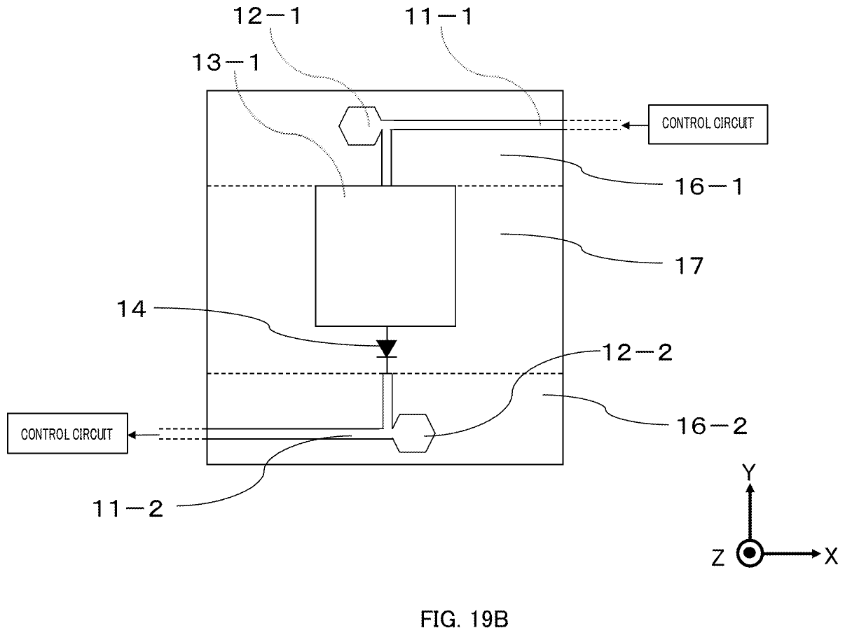

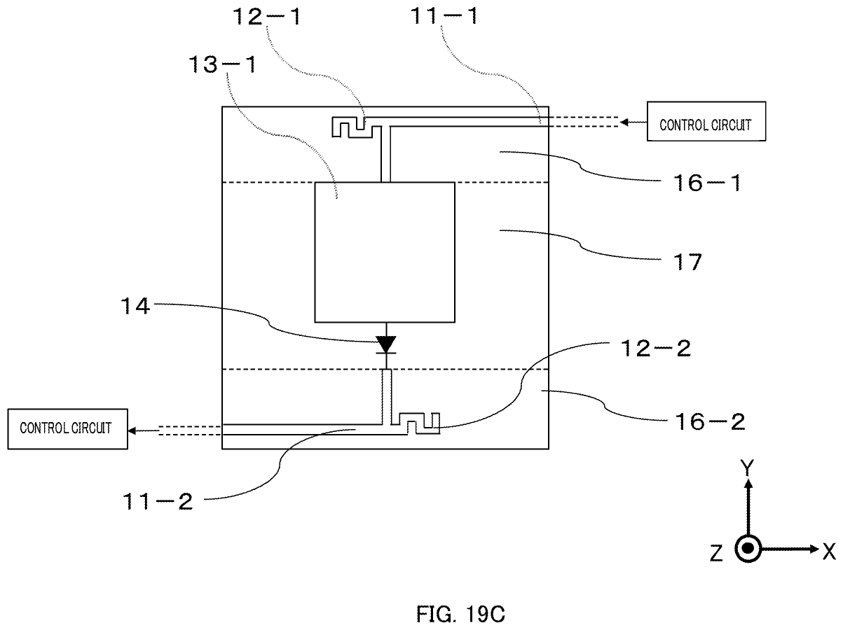

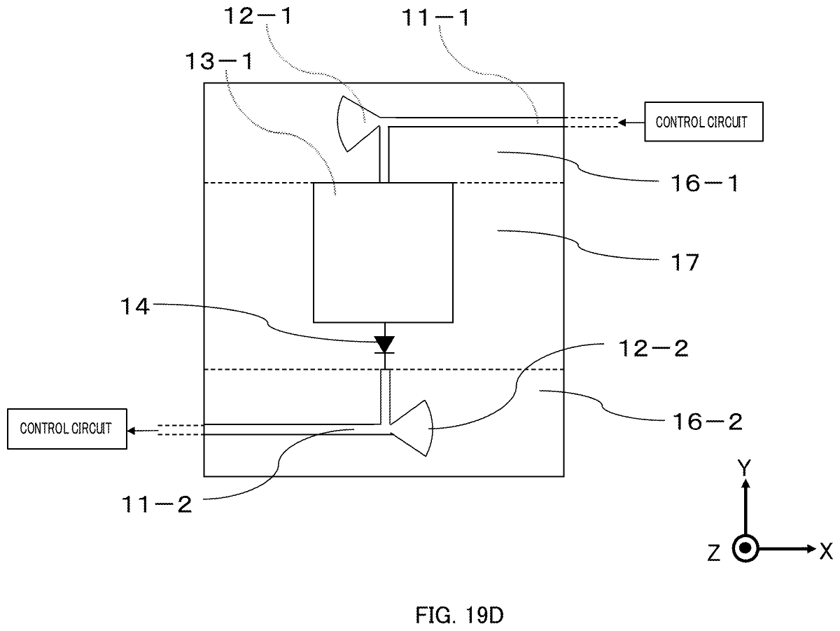

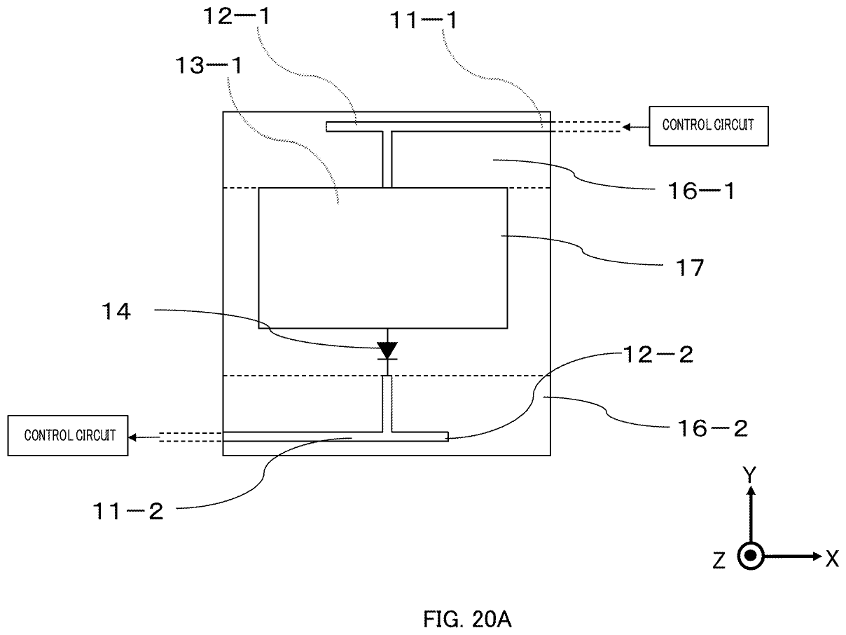

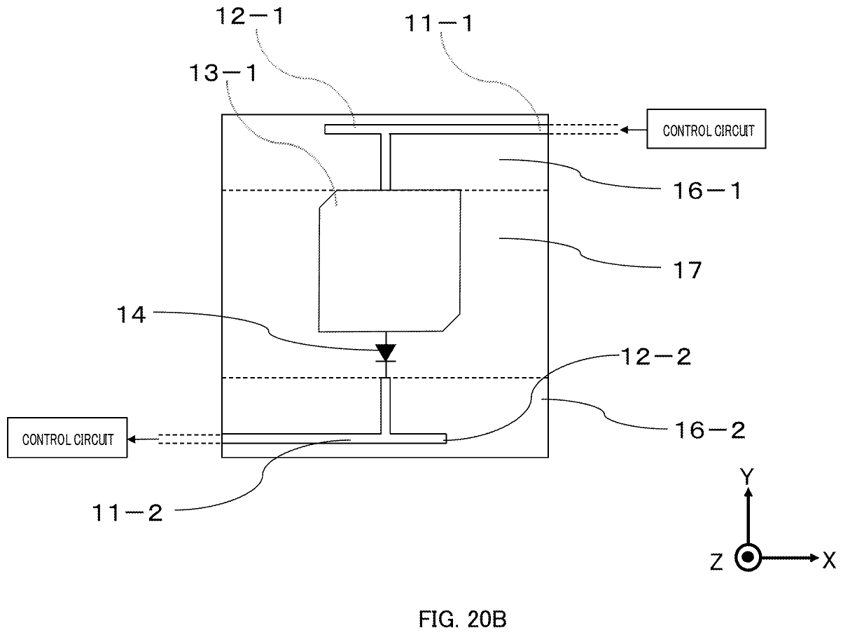

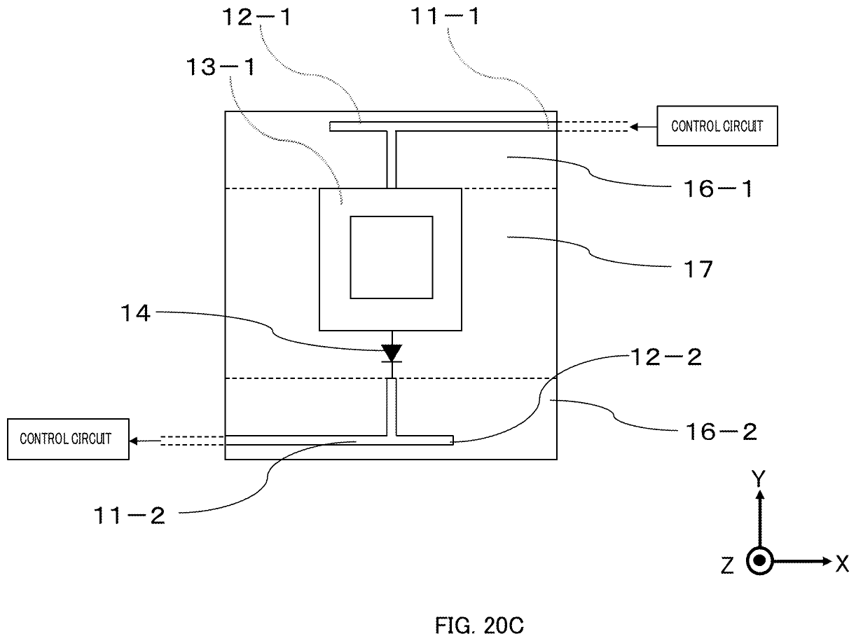

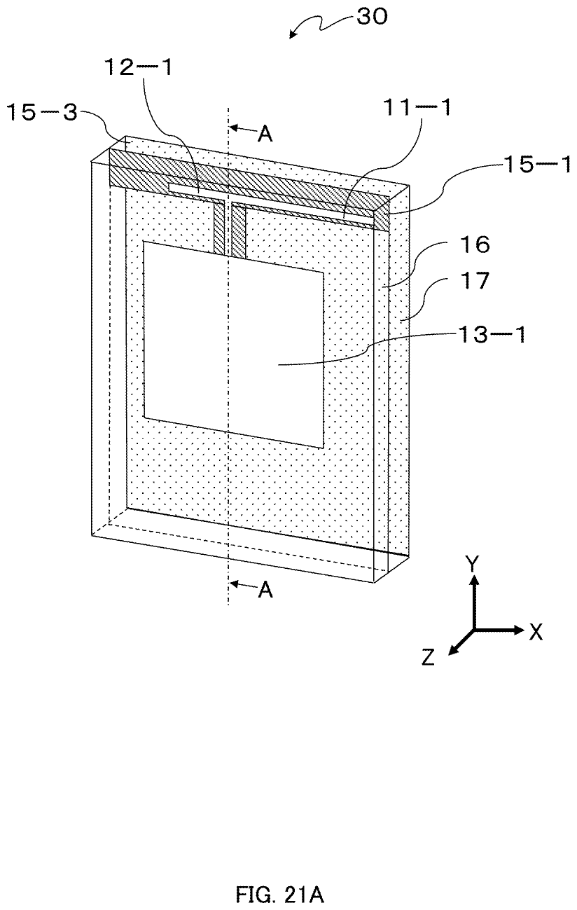

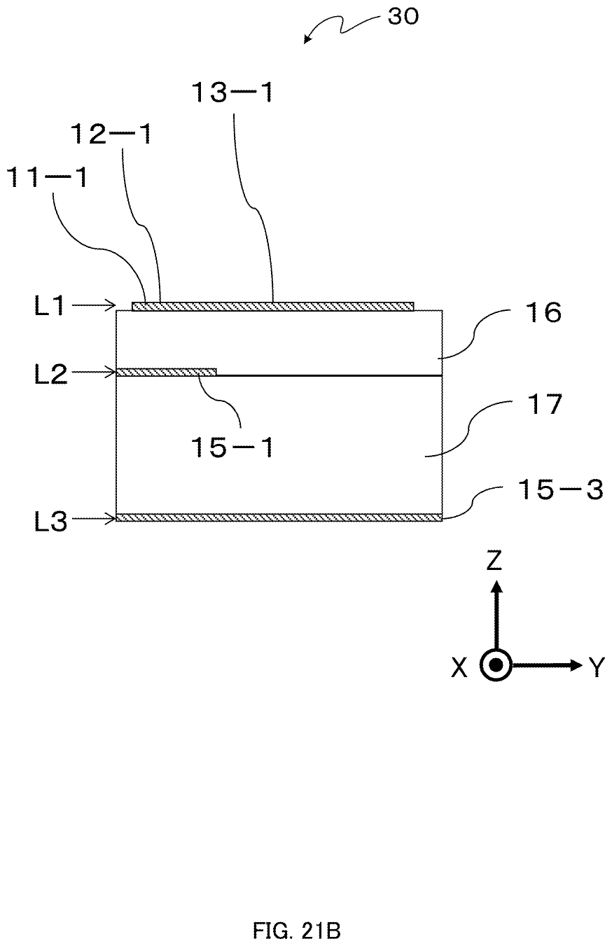

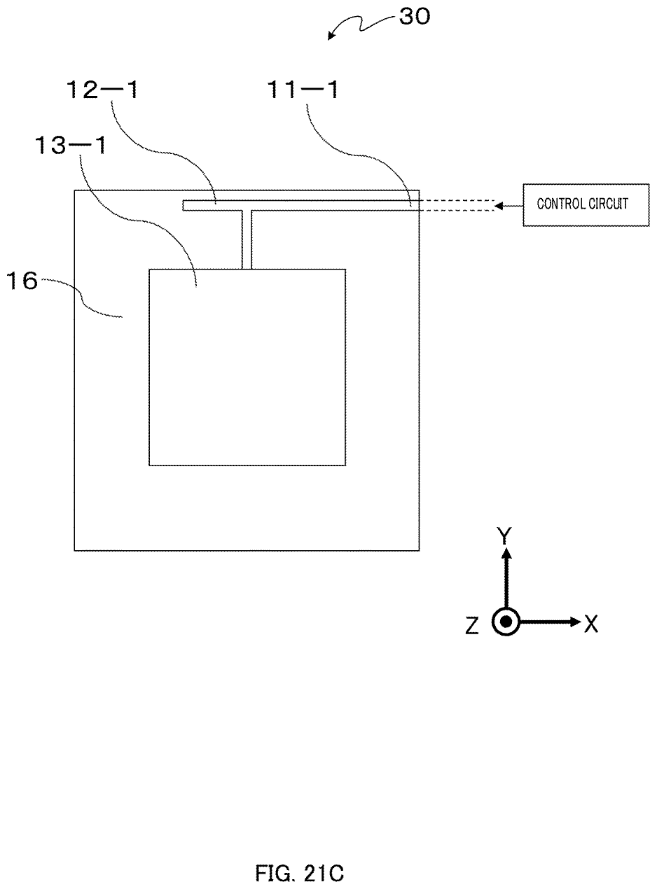

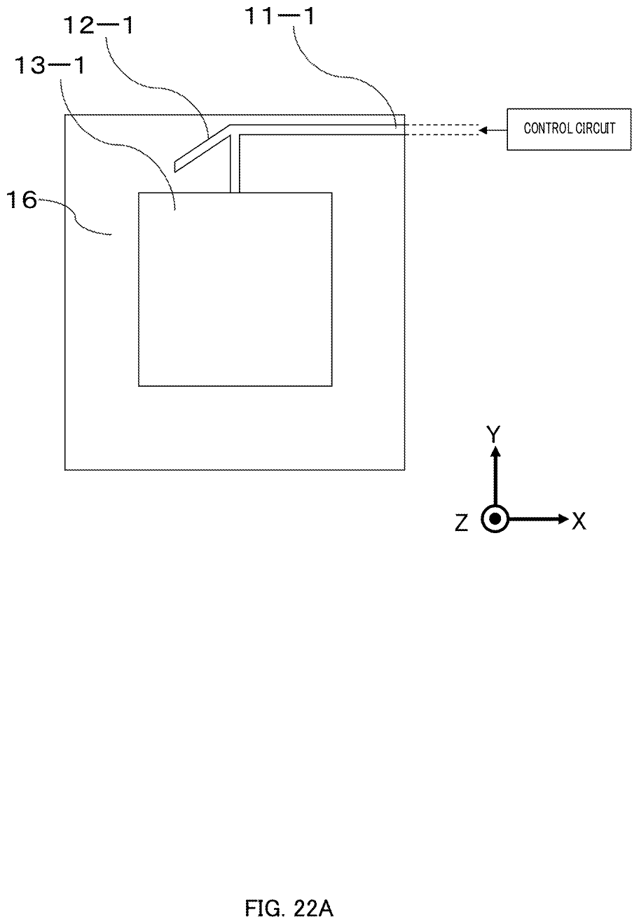

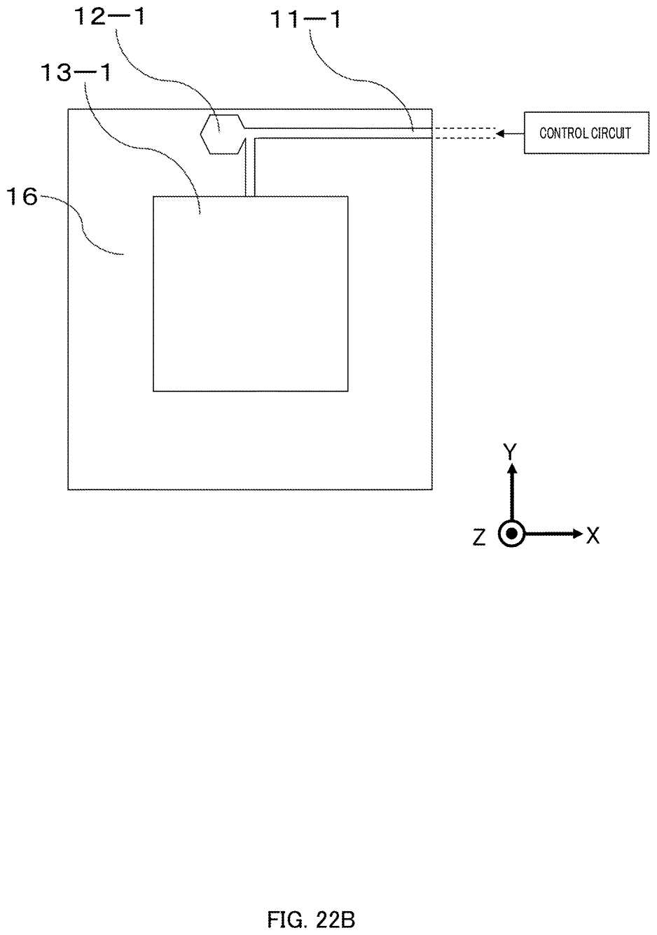

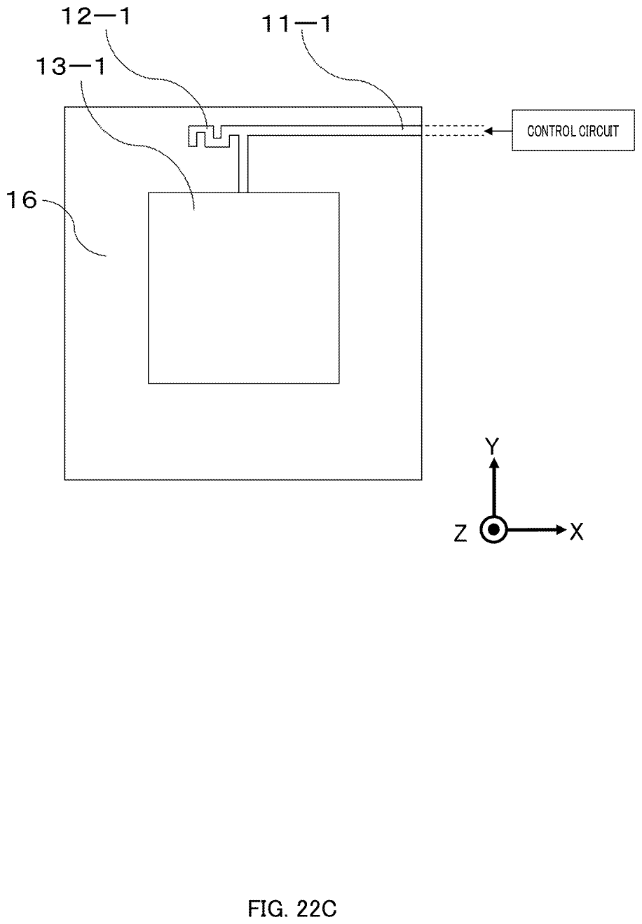

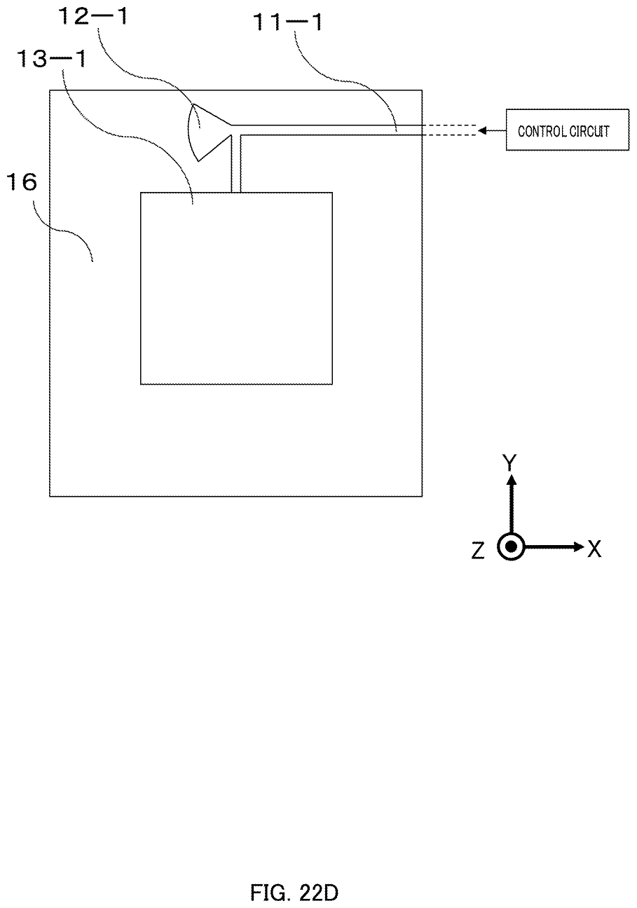

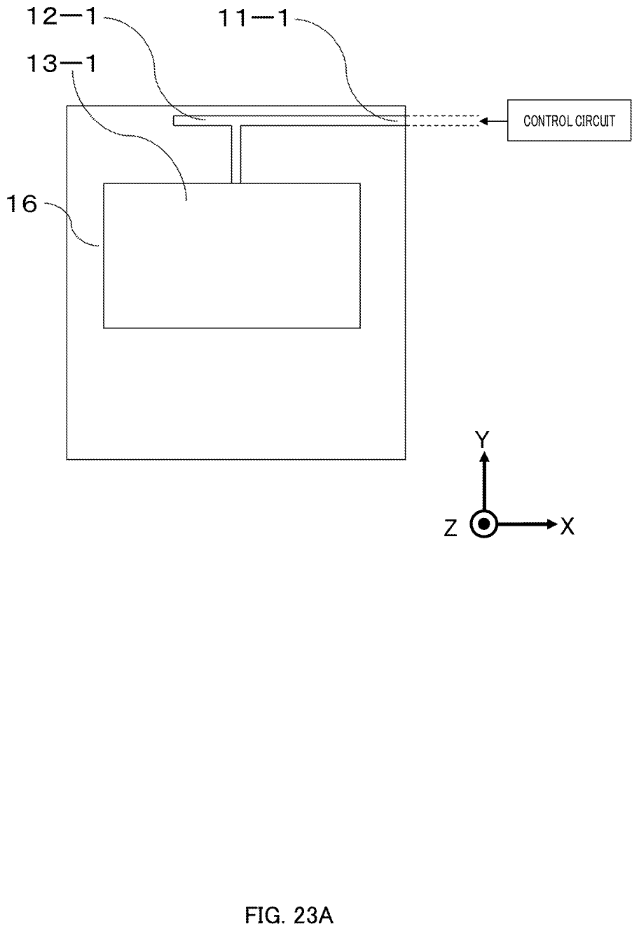

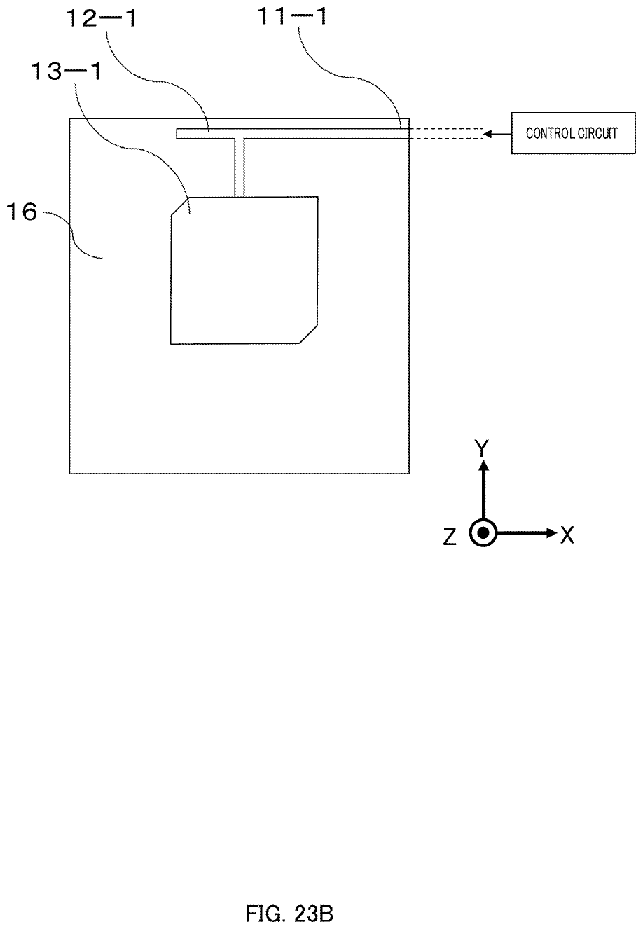

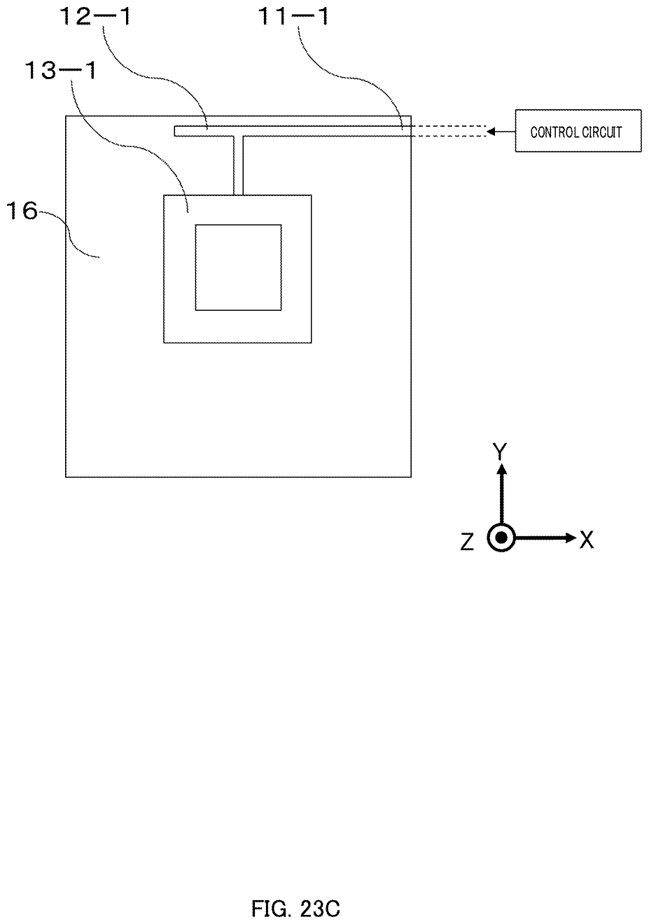

FIG. 2B is a cross-sectional view taken along an A-A arrow of cell 10 of FIG. 2A. FIG. 2C is a front view of cell 10. As illustrated in FIGS. 2A, 2B, and 2C, cell 10 includes a dielectric board on which dielectrics 16 and 17 and conductor layers (copper plates) are stacked.

As illustrated in FIG. 2B, cell 10 includes layer L1 of a conductor layer, which is formed on a front surface (surface layer) of dielectric 16, layer L2 of a conductor layer, which is formed to sandwich dielectric 16 immediately below layer L1, and layer L3 of a conductor layer, which is formed to sandwich dielectric 17 immediately below layer L2.

As illustrated in FIGS. 2A and 2C, antenna element 13-1 and bias line 11-1 electrically connected to antenna element 13-1 are formed in layer L1. Stub 12-1 is connected to (formed on) bias line 11-1.

In addition, bias line 11-2 to which stub 12-2 is connected is formed in layer L1. Diode 14 is connected between bias line 11-2 and antenna element 13-1. Diode 14 is, for example, a p-intrinsic-n (PIN) diode.

As illustrated in FIGS. 2A and 2B, in layer L2, ground 15-1 is formed below bias line 11-1 and stub 12-1. In addition, in layer L2, ground 15-2 is formed below bias line 11-2 and stub 12-2. The ground may also be referred to as a ground pattern.

As illustrated in FIGS. 2A and 2B, in layer L3, ground 15-3 is formed below antenna element 13-1. Grounds 15-1 and 15-2 may be electrically connected to ground 15-3.

The control circuit illustrated in FIG. 2C applies a bias voltage to diode 14. Diode 14 is turned on and off by the bias voltage to connect antenna element 13-1 and bias line 11-2 and disconnect antenna element 13-1 from bias line 11-2. The impedance characteristics of antenna element 13-1 are changed by on and off operations of diode 14.

A choke circuit is formed of a microstrip line composed of stubs 12-1 and 12-2, dielectric 16, and grounds 15-1 and 15-2. In the present disclosure, the choke circuit suppresses (reduces) a high-frequency signal superposed on bias lines 11-1 and 11-2.

In a microstrip line according to an existing technology, radiation from the microstrip line decreases as the thickness of the board is smaller. In cell 10, grounds 15-1 and 15-2 are formed in layer L2, and thus, the interlayer distance between stubs 12-1 and 12-2 and the interlayer distance between bias lines 11-1 and 11-2 are physically reduced as compared with the interlayer distance between antenna element 13-1 in layer L1 and ground 15-3 in layer L3. For this reason, cell 10 suppresses a decrease in the radiation performance of antenna element 13-1 and reduces spurious radiation from the choke circuit and bias lines 11-1 and 11-2.

Stubs 12-1 and 12-2 are conductors connected in parallel to bias lines 11-1 and 11-2, respectively. Stubs 12-1 and 12-2 generate reflected waves that are in reverse phase to high-frequency signals flowing through bias lines 11-1 and 11-2 and cause the high-frequency signals and the reflected waves to cancel each other out, thereby performing high-frequency isolation between bias lines 11-1 and 11-2 and antenna element 13-1. As described above, in cell 10, grounds 15-1 and 15-2 are formed in layer L2, and thus, the interlayer distance between stubs 12-1 and 12-2 and the interlayer distance between bias lines 11-1 and 11-2 are physically reduced as compared with the interlayer distance between antenna element 13-1 in layer L1 and ground 15-3 in layer L3. Thus, cell 10 suppresses a decrease in the radiation performance of antenna element 13-1 and improves the high-frequency isolation performance of the choke circuit. Note that, the measure for an effect of high-frequency isolation is defined as the high-frequency isolation performance.

In cell 10, interlayer distance X between the choke circuit and bias lines 11-1 and 11-2, and grounds 15-1 and 15-2 (the distance between layers L1 and L2 illustrated in FIG. 2B) and interlayer distance Y between antenna element 13-1 and ground 15-3 (the distance between layers L1 and L3 illustrated in FIG. 2B) are individually set (designed). For this reason, cell 10 makes it possible to achieve both a desired radiation performance of antenna element 13-1 and a desired radiation degree of influence in the choke circuit and bias lines 12-1 and 12-1. In cell 10, interlayer distance X is relatively set to be smaller than interlayer distance Y, thereby realizing a high radiation performance of antenna element 13-1 and realizing a low radiation degree of influence in the choke circuit and bias lines 12-1 and 12-1.

### Verification 1

The present inventors have verified that cell 10 reduces the radiation degree of influence in the choke circuit and the bias line as compared with a cell according to an existing technology, by an electromagnetic field simulation using a finite integral method. Hereinafter, cells used for the verification will be indicated.

The cell illustrated in FIGS. 3A and 3B is a variation of cell 10 illustrated in FIGS. 2A, 2B, and 2C. In the cell illustrated in FIGS. 3A and 3B, antenna element 13-2 is formed between diode 14 and bias line 11-2 in layer L1. Even in the cell in the variation illustrated in FIGS. 3A and 3B, the radiation performance of the antenna element improves and the radiation degree of influence in the choke circuit and the bias line is reduced in the same manner as in cell 10 described in FIGS. 2A, 2B, and 2C.

In a cell according to an existing technology illustrated in FIGS. 5A and 5B, grounds 15-1 and 15-2 in layer L2 are omitted from the cell in the variation illustrated in FIGS. 3A and 3B.

In the present verification, reflection characteristics in a case where a plane wave with the YZ plane serving as the electric field plane is caused to be incident on each cell from the +Z direction have been compared.

Reflection amplitudes and reflection phases in the cell in the variation according to the present disclosure illustrated in FIGS. 3A and 3B and the cell illustrated in FIG. 4 in which bias lines 11-1 and 11-2 and stubs 12-1 and 12-2 are omitted from the cell in the variation are illustrated in FIGS. 7A and 7B, respectively.

Reflection amplitudes and reflection phases in the cell according to the existing technology illustrated in FIGS. 5A and 5B and the cell illustrated in FIG. 6 in which bias lines 11-1 and 11-2 and stubs 12-1 and 12-2 are omitted from the cell according to the existing technology are illustrated in FIGS. 8A and 8B, respectively.

As the high-frequency isolation performance is higher (as the radiation degree of influence is lower), the change in the reflection characteristics (reflection amplitude and reflection phase) due to the presence or absence of bias lines 11-1 and 11-2 and stubs 12-1 and 12-2 is smaller.

The change in the reflection characteristics due to the presence or absence of bias lines 11-1 and 11-2 and stubs 12-1 and 12-2 is smaller in the cell in the variation according to the present disclosure illustrated in FIGS. 7A and 7B in comparison with the reflection characteristics of the cell according to the existing technology illustrated in FIGS. 8A and 8B. It can be therefore seen that the radiation degree of influence in the cell in the variation according to the present disclosure is lower than the radiation degree of influence in the cell according to the existing technology.

Although the reflection characteristics in the cell in the variation according to the present disclosure have been described above, the change in the reflection characteristics due to the presence or absence of bias lines 11-1 and 11-2 and stubs 12-1 and 12-2 is also small in cell 10 according to the present disclosure illustrated in FIGS. 2A, 2B, and 2C in the same manner.

### Verification 2

The present inventors have also performed a verification using the following comparative examples in order to promote understanding of the effect of cell 10.

Hereinafter, the cell illustrated in FIGS. 9A and 9B will be referred to as Comparative Example 1.

Comparative Example 1 includes a dielectric board on which dielectrics A and B and conductor layers are stacked. As illustrated in FIG. 9B, Comparative Example 1 includes layers L1 to L3. Layer L1 is formed on a front surface of dielectric A, and includes a stub and a bias line. Layer L2 is formed on a back surface of dielectric A, and includes a ground. Layer L3 is formed on a back surface of dielectric B, and includes a ground on the entire back surface of dielectric B.

Note that, the line width of the microstrip line is configured to be 0.05 mm. The ground width in layer L2 is configured to be 0.46 mm. The interlayer distance between layers L1 and L2 is configured to be approximately 1.4% of the effective wavelength. The interlayer distance between layer L1 and layer L3 is configured to be approximately 14% of the effective wavelength. Dielectrics A and B are configured to be made of the same material. Note that, the effective wavelength refers to the wavelength of a high-frequency signal for which the wavelength shortening effect attainable by a high-frequency dielectric is taken into consideration.

Hereinafter, the cell illustrated in FIGS. 10A and 10B will be referred to as Comparative Example 2. In Comparative Example 2, the ground in layer L2 is omitted from the cell according to the present disclosure illustrated in FIGS. 9A and 9B.

Each of the lengths of the stubs illustrated in FIGS. 9A, 9B, 10A, and 10B has been adjusted such that the isolation between ports 1 and 2 is maximized at 28 GHz.

FIG. 11A is a diagram illustrating isolation characteristics in ports 1 and 2 at 28 GHz. As illustrated in FIG. 11A, it can be seen that Comparative Example 1 including the ground in layer L2 has higher isolation than Comparative Example 2 including no ground in layer L2.

FIG. 11B is a diagram illustrating radiation power at the time of input of 0.5 W at 28 GHz. As illustrated in FIG. 11B, it can be seen that Comparative Example 1 including the ground in layer L2 has smaller power radiated into the space than Comparative Example 2 including no ground in layer L2.

The results illustrated in FIGS. 11A and 11B indicate that in Comparative Example 1 according to the present disclosure, the isolation between the ports is higher and the power radiated into the space is smaller than those in Comparative Example 2 according to an existing technology. It can be therefore seen that the radiation degree of influence in the choke circuit and the bias line in Comparative Example 1 according to the present disclosure is lower than that in Comparative Example 2 according to the existing technology.

FIG. 12A is a diagram illustrating isolation characteristics when the interlayer distance is changed in Comparative Example 1. FIG. 12B illustrates radiation power when the interlayer distance is changed in Comparative Example 1. Note that, since various characteristics depend on the ground area in layer L2 in addition to the interlayer distance, a verification has been performed by configuring the ground illustrated in layer 2 to have the same size as layer 3.

As illustrated in FIGS. 12A and 12B, it can be seen that the radiation degree of influence in the choke circuit and the bias line is reduced as the interlayer distance (the interlayer distance for which wavelength shortening is taken into consideration) between layers L1 and L2 is smaller. Further, it can be seen that when the interlayer distance between layer L1 and layer L2 is equal to or less than 8% of the effective wavelength, the radiation power is equal to or less than 1/10 of the input power and spurious radiation is sufficiently reduced.

As described above, the isolation characteristics and the radiation power depend on the ground area in layer L2. For this reason, as the ground area in layer L2 is larger, an ideal microstrip line is realized. Nonetheless, the ground area in layer L2 may be a ground area that allows the effect of reducing the radiation degree of influence in the choke circuit and the bias line to be obtained.

### Summary of Embodiment 1

As described above, antenna apparatus 1 includes: a board; antenna element 13-1 that is formed on a board front surface; bias lines 11-1 and 11-2 that are formed on the board front surface and connect antenna element 13-1 and a control circuit that controls the impedance characteristics of antenna element 13-1; and a choke circuit that is formed on the board front surface and suppresses a high-frequency signal superposed on bias lines 11-1 and 11-2. A first electrical length, which is an electrical length in the thickness direction of the board in a portion where antenna element 13-1 is formed, and a second electrical length, which is an electrical length in the thickness direction of the board in a portion where the choke circuit is formed, are different from each other. For example, in antenna apparatus 1, a first distance between antenna element 13-1 and ground 15-3 and a second distance between bias lines 11-1 and 11-2 and the choke circuit, and grounds 15-1 and 15-2 are different from each other, and the first electrical length and the second electrical length are different from each other.

With this configuration, antenna apparatus I makes it possible to independently adjust the radiation performance of antenna element 13-1 and the radiation degree of influence in the choke circuit and bias lines 11-1 and 11-2 by setting (designing) such that the first distance and the second distance are different from each other, and is therefore capable of satisfying a desired radiation performance and a desired radiation degree of influence.

### Variations

In the above description, the impedance characteristics of antenna element 13-1 are changed by diode 14, but the present disclosure is not limited thereto. For example, cell 10 may cause the impedance characteristics of antenna element 13-1 to be changed by using a switch element such as an FET transistor.

Dielectrics 16 and 17 may be made of the same material or may be made of different materials. In a case where a relative permittivity of dielectric 17 is lower than a relative permittivity of dielectric 16, the effective interlayer distance between layers L1 and L3 is larger due to the wavelength shortening effect than that in a case where the relative permittivities of dielectrics 16 and 17 are the same. By configuring the relative permittivity of dielectric 17 to be lower than the relative permittivity of dielectric 16, the radiation degree of influence in the choke circuit and the bias line is further reduced, and the radiation performance from the antenna element is further increased.

The closer the angle formed by the connection position between bias line 11-1 and antenna element 13-1 and the connection position between diode 14 and antenna element 13-1 as viewed from the center of antenna element 13-1 is to the right angle, the more the operation approaches the operation of the circularly polarized wave antenna by a two-point feeding method and the more polarization losses due to circular polarization occur. For this reason, the connection position between bias line 11-1 and antenna element 13-1 and the connection position between diode 14 and antenna element 13-1 are disposed on a straight line passing through antenna element 13-1. With this structure, in addition to the effect of the present invention, polarization losses are further reduced.

Each of stubs 12-1 and 12-2 is a microstrip line that is formed by combining dielectric 16 and ground 15-1, 15-2 therewith. Stubs 12-1 and 12-2 generate reflected waves that are in reverse phase to high-frequency signals flowing through bias lines 11-1 and 11-2 and cause the high-frequency signals and the reflected waves to cancel each other out, thereby reducing the high-frequency signals flowing through the bias lines. Stubs 12-1 and 12-2 are not limited to the microstrip line described above, and any element or circuit may be used as long as the element or circuit attains an effect of reducing the high-frequency signals flowing through the bias lines.

The shape of stubs 12-1 and 12-2 is not limited to a rectangular shape as illustrated in FIG. 2C as long as stubs 12-1 and 12-2 are formed by a microstrip line utilizing grounds 15-1 and 15-2. For example, stubs 12-1 and 12-2 may be parallelograms as illustrated in FIG. 13A. Stubs 12-1 and 12-2 may have a polygonal shape as illustrated in FIG. 13B. Stubs 12-1 and 12-2 may have a crank shape as illustrated in FIG. 13C. Stubs 12-1 and 12-2 may have a fan shape as illustrated in FIG. 13D. Stubs 12-1 and 12-2 may have any shape with no vertex (corner). In addition, grounds 15-1 and 15-2 may have any shape as long as grounds 15-1 and 15-2 are located below stubs 12-1 and 12-2.

Even the shape of antenna element 13-1 is not limited to a square shape as illustrated in FIG. 2C as long as antenna element 13-1 is formed by a microstrip line utilizing ground 15-3. The shape of antenna element 13-1 may be a rectangular shape as illustrated in FIG. 14A. The shape of antenna element 13-1 may be a hexagonal shape as illustrated in FIG. 14B. The shape of antenna element 13-1 may be a loop shape as illustrated in FIG. 14C. The shape of antenna element 13-1 may be any shape with no vertex. In addition, ground 15-3 may have any shape as long as ground 15-3 is located below antenna element 13-1.

The applications of the antenna apparatus are not limited to that for reflecting incident electromagnetic waves in any direction, and may be used in an application for causing incident electromagnetic waves to pass through in any direction. In addition, the antenna apparatus may also be used as an application for transmitting and receiving electromagnetic waves by providing a power feed line in antenna element 13-1.

### Embodiment 2

In Embodiment 2, a structure in which the effective interlayer distance between the antenna element and the ground and the effective interlayer distance between the bias line and the ground vary depending on the permittivity of the dielectric will be described.

Cell 20 according to Embodiment 2 includes dielectrics 16-1 and 16-2, and dielectric 17 having a permittivity lower than that of dielectrics 16-1 and 16-2.

As illustrated in FIG. 15B, cell 20 includes layer L1 of a conductor layer formed on a front surface (surface layer) of dielectrics 16-1, 16-2, and 17, and layer L2 of a conductor layer, which is formed to sandwich dielectrics 16-1, 16-2, and 17 immediately below layer L1.

As illustrated in FIGS. 15A and 15C, antenna element 13-1 and bias line 11-1 electrically connected to antenna element 13-1 are formed in layer L1. Stub 12-1 is connected to bias line 11-1.

In addition, bias line 11-2 to which stub 12-2 is connected is formed in layer L1. Diode 14 is connected between bias line 11-2 and antenna element 13-1. Diode 14 is, for example, a PIN diode.

As illustrated in FIGS. 15A and 15B, in layer L2, ground 15-1 is formed below bias line 11-1 and stub 12-1. In addition, in layer L2, ground 15-2 is formed below bias line 11-2 and stub 12-2.

As illustrated in FIGS. 15A and 15B, in layer L2, ground 15-3 is formed below antenna element 13-1. Grounds 15-1 and 15-2 may be electrically connected to ground 15-3.

Dielectric 16-1 is disposed below bias line 11-1 and stub 12-1. Dielectric 16-2 having the same permittivity as dielectric 16-1 is disposed below bias line 11-2 and stub 12-2. Dielectric 17 having a lower permittivity than dielectrics 16-1 and 16-2 is disposed below antenna element 13-1.

In cell 20 illustrated in FIGS. 15A, 15B, and 15C, a desired radiation performance of the antenna element and a desired radiation degree of influence in the choke circuit and the bias line are obtained by a board of two types of dielectrics 16-1 and 16-2 and dielectric 17 for which two conductor layers (layers L1 and L2) are formed.

For example, dielectrics 16-1 and 16-2 have a higher permittivity than dielectric 17, and have a smaller electrical length from the surface layer to the back surface due to the wavelength shortening effect. For this reason, the effective interlayer distance between bias lines 11-1 and 11-2 and stubs 12-1 and 12-2, and grounds 15-1 and 15-2 is smaller than the effective interlayer distance between antenna element 13-1 and ground 15-3. With this configuration, even in cell 20 according to Embodiment 2, the radiation performance of antenna element 13-1 improves and the radiation degree of influence in the choke circuit and the bias line is reduced in the same manner as in cell 10 according to Embodiment 1.

### Summary of Embodiment 2

As described above, antenna apparatus 1 includes: a board; antenna element 13-1 that is formed on a board front surface; bias lines 11-1 and 11-2 that are formed on the board front surface and connect antenna element 13-1 and a control circuit that controls the impedance characteristics of antenna element 13-1; and a choke circuit that is formed on the board front surface and suppresses a high-frequency signal superposed on bias lines 11-1 and 11-2. A first electrical length, which is an electrical length in the thickness direction of the board in a portion where antenna element 13-1 is formed, and a second electrical length, which is an electrical length in the thickness direction of the board in a portion where the choke circuit is formed, are different from each other. For example, in antenna apparatus 1, a first permittivity between antenna element 13-1 and ground 15-3 and a second permittivity between bias lines 11-1 and 11-2 and the choke circuit, and grounds 15-1 and 15-2 are different from each other, and the first electrical length and the second electrical length are different from each other.

With this configuration, antenna apparatus 1 makes it possible to independently adjust the radiation performance of antenna element 13-1 and the radiation degree of influence in the choke circuit and bias lines 11-1 and 11-2 by setting (designing) such that the first permittivity and the second permittivity are different from each other, and is therefore capable of satisfying a desired radiation performance and a desired radiation degree of influence.

### Variations

The cell may not be a single-layer board as illustrated in FIGS. 15A, 15B, and 15C. The cell may be a multilayer board as illustrated in FIGS. 16A and 16B. As illustrated in FIGS. 17A and 17B, the cell may have a structure in which the physical interlayer distance from the conductor layer of the surface layer to the ground is different. The cell may have a structure in which the effective interlayer distance between the bias lines and the stubs, and the ground is smaller than the effective interlayer distance between the antenna element and the ground. Even with these configurations, the radiation degree of influence in the choke circuit and the bias line is reduced in the cell.

As illustrated in FIGS. 18A and 18B, the cell may include antenna element 13-2 between diode 14 and bias line 11-2 in layer L1. Even with this configuration, the cell reduces the radiation degree of influence in the choke circuit and the bias line.

As in Embodiment 1, as the effective interlayer distance between bias lines 11-1 and 11-2 and stubs 12-1 and 12-2, and grounds 15-1 and 15-2 is smaller, the radiation degree of influence in the choke circuit and the bias line is reduced. When the interlayer distance is equal to or less than 8% of the effective wavelength, the radiation degree of influence is sufficiently attenuated, but the present disclosure is not limited thereto.

As in Embodiment 1, as the area of grounds 15-1 and 15-2 below bias lines 11-1 and 11-2 and stubs 12-1 and 12-2 is larger, an ideal microstrip line is realized. Nonetheless, the area of grounds 15-1 and 15-2 may be a ground area that allows the effect of reducing the radiation degree of influence in the choke circuit and the bias line to be obtained.

As in Embodiment 1, the closer the angle formed by the connection position between bias line 11-1 and antenna element 13-1 and the connection position between diode 14 and antenna element 13-1 as viewed from the center of antenna element 13-1 is to the right angle, the more the operation approaches the operation of the circularly polarized wave antenna by a two-point feeding method and the more polarization losses due to circular polarization occur. For this reason, the connection position between bias line 11-1 and antenna element 13-1 and the connection position between diode 14 and antenna element 13-1 are disposed on a straight line passing through antenna element 13-1. With this structure, in addition to the effect of the present invention, polarization losses are further reduced.

Each of stubs 12-1 and 12-2 is a microstrip line that is formed by combining dielectric 16-1, 16-2 and ground 15-1, 15-2 therewith. Stubs 12-1 and 12-2 generate reflected waves that are in reverse phase to high-frequency signals flowing through bias lines 11-1 and 11-2 and cause the high-frequency signals and the reflected waves to cancel each other out, thereby reducing the high-frequency signals flowing through the bias lines. Stubs 12-1 and 12-2 are not limited to the microstrip line, and may be any element or circuit as long as the element or circuit attains an effect of reducing the high-frequency signals flowing through the bias lines.

The shape of stubs 12-1 and 12-2 is not limited to a rectangular shape as illustrated in FIG. 15C as long as stubs 12-1 and 12-2 are formed by a microstrip line utilizing grounds 15-1 and 15-2. For example, stubs 12-1 and 12-2 may be parallelograms as illustrated in FIG. 19A. Stubs 12-1 and 12-2 may have a polygonal shape as illustrated in FIG. 19B. Stubs 12-1 and 12-2 may have a crank shape as illustrated in FIG. 19C. Stubs 12-1 and 12-2 may have a fan shape as illustrated in FIG. 19D. Stubs 12-1 and 12-2 may have any shape with no vertex. In addition, grounds 15-1 and 15-2 may have any shape as long as grounds 15-1 and 15-2 are located below stubs 12-1 and 12-2.

Even the shape of antenna element 13-1 is not limited to a square shape as illustrated in FIG. 15C as long as antenna element 13-1 is formed by a microstrip line utilizing ground 15-3. The shape of antenna element 13-1 may be a rectangular shape as illustrated in FIG. 20A. The shape of antenna element 13-1 may be a hexagonal shape as illustrated in FIG. 20B. The shape of antenna element 13-1 may be a loop shape as illustrated in FIG. 20C. The shape of antenna element 13-1 may be any shape with no vertex. In addition, ground 15-3 may have any shape as long as ground 15-3 is located below antenna element 13-1.

The applications of the antenna element are not limited to that for reflecting incident electromagnetic waves in any direction, and may be used in an application for causing incident electromagnetic waves to pass through in any direction. In addition, the antenna apparatus may also be used as an application for transmitting and receiving electromagnetic waves by providing a power feed line in antenna element 13-1.

### Embodiment 3

In Embodiments 1 and 2, the impedance characteristics of the antenna element are changed by the diode formed on the board front surface. In Embodiment 3, a case where a function of changing the impedance characteristics is provided inside the board, such as a dielectric, will be described.

Cell 30 according to Embodiment 3 includes a dielectric board on which dielectrics 16 and 17 and conductor layers are stacked.

As illustrated in FIG. 21B, cell 10 includes layer L1 of a conductor layer formed on a front surface of dielectric 16, layer L2 of a conductor layer, which is formed to sandwich dielectric 16 immediately below layer L1, and layer L3 of a conductor layer, which is formed to sandwich dielectric 17 immediately below layer L2.

As illustrated in FIGS. 21A and 21C, antenna element 13-1 and bias line 11-1 electrically connected to antenna element 13-1 are formed in layer L1. Stub 12-1 is connected to bias line 11-1.

As illustrated in FIGS. 21A and 21B, in layer L2, ground 15-1 is formed below bias line 11-1 and stub 12-1.

In layer L3, ground 15-3 is formed below antenna element 13-1. Ground 15-1 may be electrically connected to ground 15-3.

The permittivity of at least one of dielectrics 16 and 17 changes by the application of a voltage. The control circuit illustrated in FIG. 21C applies a voltage to bias line 11-1, thereby changing the permittivity of at least one of dielectrics 16 and 17. Ground 15-3 in layer L3 exerts the same function as bias line 11-2 indicated in Embodiments 1 and 2.

### Summary of Embodiment 3

As described above, in the antenna apparatus, the permittivity of the board is changed by the voltage applied from the control circuit. With this configuration, antenna apparatus 1 causes the impedance characteristics of antenna element 13-1 to be changed and makes it possible to change the reflection direction of electromagnetic waves.

### Variations

As in Embodiment 1, as the effective interlayer distance between bias line 11-1 and stub 12-1, and ground 15-1 is smaller, the radiation degree of influence in the choke circuit and the bias line is reduced. When the interlayer distance is equal to or less than 8% of the effective wavelength, the radiation degree of influence is sufficiently attenuated, but the present disclosure is not limited thereto.

As in Embodiment 1, as the area of ground 15-1 below bias line 11-1 and stub 12-1 is larger, an ideal microstrip line is realized. Nonetheless, the area of ground 15-1 may be a ground area that allows the effect of reducing the radiation degree of influence in the choke circuit and the bias line to be obtained.

Stub 12-1 is a microstrip line that is formed by combining dielectric 16 and ground 15-1 therewith. Stub 12-1 generates reflected waves that are in reverse phase to high-frequency signals flowing through bias line 11-1 and causes the high-frequency signals and the reflected waves to cancel each other out, thereby reducing the high-frequency signal flowing through the bias line. The stub is not limited to the microstrip line, and may be any element or circuit as long as the element or circuit attains an effect of reducing the high-frequency signals flowing through the bias line.

The shape of stub 12-1 is not limited to a rectangular shape illustrated in FIG. 21C as long as stub 12-1 is formed by a microstrip line utilizing ground 15-1. For example, stub 12-1 may be a parallelogram as illustrated in FIG. 22A. Stub 12-1 may have a polygonal shape as illustrated in FIG. 22B. Stub 12-1 may have a crank shape as illustrated in FIG. 22C. Stub 12-1 may have a fan shape as illustrated in FIG. 22D. Stub 12-2 may have any shape with no vertex. In addition, ground 15-1 may have any shape as long as ground 15-1 is located below stub 12-1.

Even the shape of antenna element 13-1 is not limited to a square shape as illustrated in FIG. 21C as long as antenna element 13-1 is formed by a microstrip line utilizing ground 15-3. The shape of antenna element 13-1 may be a rectangular shape as illustrated in FIG. 23A. The shape of antenna element 13-1 may be a hexagonal shape as illustrated in FIG. 23B. The shape of antenna element 13-1 may be a loop shape as illustrated in FIG. 23C. The shape of antenna element 13-1 may be any shape with no vertex. In addition, ground 15-3 may have any shape as long as ground 15-3 is located below antenna element 13-1.

The applications of the antenna element are not limited to that for reflecting incident electromagnetic waves in any direction, and may be used in an application for causing incident electromagnetic waves to pass through in any direction. In addition, the antenna apparatus may also be used as an application for transmitting and receiving electromagnetic waves by providing a power feed line in antenna element 13-1.

Although the embodiments have been described above with reference to the accompanying drawings, the present disclosure is not limited to such examples. It is obvious that a person skilled in the art can arrive at various variations and modifications within the scope described in the claims. It is understood that such variations and modifications also belong to the technical scope of the present disclosure. Further, components in the embodiments described above may be arbitrarily combined without departing from the spirit of the present disclosure.

In the embodiments described above, the notation “. . . processor”, “ . . . -er”, “ . . . -or” or “ . . . -ar” used for each component may be replaced with another notation such as “. . . circuitry”, “. . . assembly”, “. . . device”, “. . . unit” or “. . . module”.

The disclosure of Japanese Patent Application No. 2023-018334, filed on Feb. 9, 2023, including the specification, drawings, and abstract, is incorporated herein by reference in its entirety.

### INDUSTRIAL APPLICABILITY

The present disclosure is useful for an antenna apparatus such as an RIS that reflects electromagnetic waves.

### REFERENCE SIGNS LIST

1 Antenna apparatus
10 Cell
11-1, 11-2 Bias line
12-1, 12-2 Stub
13-1 Antenna element
14 Diode
15-1, 15-2 Ground
16, 17 Dielectric

1. An antenna apparatus, comprising:
a board;
an antenna element that is formed on a front surface of the board;
a line that is formed on the front surface of the board and connects the antenna element and a control circuit, the control circuit controlling an impedance characteristic of the antenna element; and
a circuit that is formed on the front surface of the board and suppresses a high-frequency signal superposed on the line, wherein
a first electrical length and a second electrical length are different from each other, the first electrical length being an electrical length in a thickness direction of the board in a portion where the antenna element is formed, the second electrical length being an electrical length in the thickness direction of the board in a portion where the circuit is formed.

2. The antenna apparatus according to claim 1, wherein
the first electrical length is larger than the second electrical length.

3. The antenna apparatus according to claim 1, wherein
a first ground facing the antenna element and a second ground facing the line and the circuit are formed in the board.

4. The antenna apparatus according to claim 3, wherein
a distance between the antenna element and the first ground is larger than a distance between the line and the circuit, and the second ground.

5. The antenna apparatus according to claim 3, wherein
a permittivity between the antenna element and the first ground and a permittivity between the line and the circuit, and the second ground are different from each other.

6. The antenna apparatus according to claim 5, wherein
the permittivity between the antenna element and the first ground is smaller than the permittivity between the line and the circuit, and the second ground.

7. The antenna apparatus according to claim 1, wherein:
a first ground facing the antenna element and a second ground facing the line and the circuit are formed in an identical layer of the board; and
a permittivity between the antenna element and the first ground and a permittivity between the line and the circuit, and the second ground are different from each other.

8. The antenna apparatus according to claim 7, wherein
the permittivity between the antenna element and the first ground is smaller than the permittivity between the line and the circuit, and the second ground.

9. The antenna apparatus according to claim 1, wherein
a permittivity of the board is changed by a voltage applied from the control circuit.

10. The antenna apparatus according to claim 1, wherein:
an element that is connected to the antenna element and changes the impedance characteristic of the antenna element is formed on the front surface of the board; and
the element is connected to the control circuit via the antenna element and the line.

11. The antenna apparatus according to claim 10, wherein
a connection position between the line and the antenna element is parallel to a connection direction of the element that changes the impedance characteristic.
